(19) United States
(12) Patent Application Publication
(10) Pub. No.: US 2025/0085224 A1
(43) Pub. Date: Mar. 13, 2025

(54) SYSTEMS AND METHODS FOR INFERRING POTENTIAL ENERGY LANDSCAPES FROM FRET EXPERIMENTS

(71) Applicants: Shep Bryan, Phoenix, AZ (US); Steve Presse, Scottsdale, AZ (US)

(72) Inventors: Shep Bryan, Phoenix, AZ (US); Steve Presse, Scottsdale, AZ (US)

(73) Assignee: Arizona Board of Regents on Behalf of Arizona State University, Tempe, AZ (US)

(21) Appl. No.: 18/827,224

(22) Filed: Sep. 6, 2024

Related U.S. Application Data
(60) Provisional application No. 63/537,122, filed on Sep. 7, 2023.

(51) Int. Cl. G01N 21/64; G06N 7/01

(52) U.S. Cl. CPC G01N 21/6428; G06N 7/01; G01N 2021/6439; G01N 2201/126

(57) ABSTRACT

A system infers continuous potential energy landscapes, including barrier heights and friction coefficients, from smFRET data without the need to discretely approximate a state-space. The system operates within a Bayesian nonparametric paradigm by placing priors on the family of all possible potential curves, and leverages a Structured-Kernel-Interpolation Gaussian Process prior to help curtail computational cost. The system enables decoding information about continuous energy potential landscapes along a continuous coordinate for biological interactions (e.g., protein folding and binding) using a single dataset, including rarely visited barriers between putative potential minima. As such, the system allows resolution enhancement for probing biophysical systems to obtain deeper insight into protein folding, protein binding, and the physics of molecular motors.

### CROSS REFERENCE TO RELATED APPLICATIONS

This is a non-provisional application that claims benefit to U.S. Provisional Application Ser. No. 63/537,122, filed on Sep. 7, 2023, which is herein incorporated by reference in its entirety.

### GOVERNMENT SUPPORT

This invention was made with government support under 1719537 awarded by the National Science Foundation and R01 GM134426 and R01 GM130745 awarded by the National Institutes of Health. The government has certain rights in the invention.

### FIELD

The present disclosure generally relates to interpreting information about biophysical interactions from Förster resonance energy transfer (FRET) experiments, and in particular, to a system and associated methods for inferring continuous potential energy landscapes and other information about biophysical interactions from FRET experiments using a Structured-Kernel-Interpolation Gaussian Process.

### BACKGROUND

Potential energy landscapes are useful models in describing events such as protein folding and binding. While single molecule fluorescence resonance energy transfer (smFRET) experiments encode information on continuous potentials for the system probed, including rarely visited barriers between putative potential minima, this information is rarely decoded from the data. This is because existing analysis methods often model smFRET output assuming, from the onset, that the system probed evolves in a discretized state-space to be analyzed within a Hidden Markov Model (HMM) paradigm.

HMMs work by partitioning the observed smFRET efficiencies into discrete levels coinciding with distinct states. One can then use smFRET data to infer the number of states in addition to the associated transition rate parameters and pair distances. However, HMM is not appropriate when the dynamics occur along a continuous reaction coordinate poorly approximated by well separated discrete-states. While HMMs can be used to infer each state's relative energies (though parametric HMMs require a specification in the number of states), they cannot reveal energy barriers between states without preexisting knowledge of internal system parameters, such as the landscape curvature and internal friction, due to loss of information inherent to the discretization process. The inability to infer accurate potential energy barriers from a single data set without the knowledge of hidden internal parameters is an important limitation of HMMs applied to smFRET data.

It is with these observations in mind, among others, that various aspects of the present disclosure were conceived and developed.

### SUMMARY OF THE INVENTION

Disclosed herein are systems to decode a continuous potential from smFRET data without resorting to discrete state-space assumptions inherent to HMM modeling. In some embodiments, the system includes a processor in communication with a memory, the memory including instructions executable by the processor to: access a set of smFRET measurements including a series of photon measurements observed from donor-acceptor dynamics of a labeled molecule across a plurality of time steps; and measure a set of parameter values of a continuous potential energy landscape associated with the donor-acceptor dynamics of the labeled molecule for a time step of the plurality of time steps by sampling the set of parameter values from a probability distribution of a continuous potential energy landscape curve in view of the series of photon measurements and over a plurality of iterations. The set of parameter values of the continuous potential energy landscape curve can include a value of an energy potential that correlates with a pair fluorophore distance of the labeled molecule for the time step of the plurality of time steps.

The labeled molecule can include a donor fluorophore having a donor photon emission rate and an acceptor fluorophore having an acceptor photon emission rate, the donor photon emission rate and the acceptor photon emission rate correlating with the pair fluorophore distance between the donor fluorophore and the acceptor fluorophore. The series of photon measurements can include, for a time step of the plurality of time steps, a donor photon count of photons emitted from the donor fluorophore and an acceptor photon count of photons emitted from the acceptor fluorophore.

The memory can further include instructions executable by the processor to: sample, using a Structured-Kernel-Interpolation Gaussian-Process for an iteration of the plurality of iterations, the value of the energy potential at one or more inducing points selected from a pair fluorophore distance trajectory from a conditional distribution over energy potential; and interpolate a value of the energy potential for a time step of the plurality of time steps associated with the pair fluorophore distance trajectory that is excluded from the one or more inducing points.

The memory can further include instructions executable by the processor to: sample the set of parameter values using the probability distribution of the continuous potential energy landscape curve over the plurality of iterations using a Gibbs sampling scheme.

The memory can further include instructions executable by the processor to: sample, for an iteration of the plurality of iterations, the value of the pair fluorophore distance for a time step from a conditional distribution over pair fluorophore distance; sample, for an iteration of the plurality of iterations, a value of a friction coefficient of the set of parameter values from a conditional distribution over the friction coefficient; sample, for an iteration of the plurality of iterations, a value of a donor excitation rate of the set of parameter values from a conditional distribution over the donor excitation rate, the conditional distribution over the donor excitation rate correlating with a probability associated with observing the series of photon measurements; sample, for an iteration of the plurality of iterations, a value of a donor photon background rate of the set of parameter values from a conditional distribution over the donor photon background rate, the conditional distribution over the donor photon background rate correlating with a probability associated with observing the series of photon measurements; and sample, for an iteration of the plurality of iterations, a value of an acceptor photon background rate of the set of parameter values from a conditional distribution over the acceptor photon background rate, the conditional distribution over the acceptor photon background rate correlating with a probability associated with observing the series of photon measurements.

The memory can further include instructions executable by the processor to: determine a most probable set of parameter values of the continuous potential energy landscape based on the set of parameter values sampled using the probability distribution of the continuous potential energy landscape curve over the plurality of iterations.

Disclosed herein are methods to decode a continuous potential from smFRET data without resorting to discrete state-space assumptions inherent to HMM modeling. In a further aspect, a method includes: accessing a set of smFRET measurements including a series of photon measurements observed from donor-acceptor dynamics of a labeled molecule across a plurality of time steps, the series of photon measurements including, for a time step of the plurality of time steps, a donor photon count of photons emitted from a donor fluorophore of the labeled molecule and an acceptor photon count of photons emitted from an acceptor fluorophore of the labeled molecule; and measuring a set of parameter values of a continuous potential energy landscape associated with the donor-acceptor dynamics of the labeled molecule for a time step of the plurality of time steps by sampling the set of parameter values from a probability distribution of a continuous potential energy landscape curve in view of the series of photon measurements and over a plurality of iterations. The set of parameter values of the continuous potential energy landscape curve can include a value of an energy potential that correlates with a pair fluorophore distance of the labeled molecule for the time step of the plurality of time steps.

The method can further include: sampling, using a Structured-Kernel-Interpolation Gaussian-Process for an iteration of the plurality of iterations, the value of the energy potential at one or more inducing points selected from a pair fluorophore distance trajectory from a conditional distribution over energy potential.

The method can further include: sampling, for an iteration of the plurality of iterations, the value of the pair fluorophore distance for a time step from a conditional distribution over pair fluorophore distance; sampling, for an iteration of the plurality of iterations, a value of a friction coefficient of the set of parameter values from a conditional distribution over the friction coefficient; sampling, for an iteration of the plurality of iterations, a value of a donor excitation rate of the set of parameter values from a conditional distribution over the donor excitation rate, the conditional distribution over the donor excitation rate correlating with a probability associated with observing the series of photon measurements; sampling, for an iteration of the plurality of iterations, a value of a donor photon background rate of the set of parameter values from a conditional distribution over the donor photon background rate, the conditional distribution over the donor photon background rate correlating with a probability associated with observing the series of photon measurements; and sampling, for an iteration of the plurality of iterations, a value of an acceptor photon background rate of the set of parameter values from a conditional distribution over the acceptor photon background rate, the conditional distribution over the acceptor photon background rate correlating with a probability associated with observing the series of photon measurements.

Disclosed herein are one or more non-transitory computer readable media includes instructions encoded thereon that are executable by a processor to decode a continuous potential from smFRET data without resorting to discrete state-space assumptions inherent to HMM modeling. In a further aspect, one or more non-transitory computer readable media includes instructions encoded thereon that are executable by a processor to: access a set of smFRET measurements including a series of photon measurements observed from donor-acceptor dynamics of a labeled molecule across a plurality of time steps, the series of photon measurements including, for a time step of the plurality of time steps, a donor photon count of photons emitted from a donor fluorophore of the labeled molecule and an acceptor photon count of photons emitted from an acceptor fluorophore of the labeled molecule; and measure a set of parameter values of a continuous potential energy landscape associated with the donor-acceptor dynamics of the labeled molecule for a time step of the plurality of time steps by sampling the set of parameter values from a probability distribution of a continuous potential energy landscape curve in view of the series of photon measurements and over a plurality of iterations. The set of parameter values of the continuous potential energy landscape curve can include a value of an energy potential that correlates with a pair fluorophore distance of the labeled molecule for the time step of the plurality of time steps.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1A is a diagram showing a system (SKIPPER-FRET) for decoding a continuous potential from smFRET data in accordance with aspects of the present disclosure;

FIG. 1B is a diagram showing a computational scheme of the system of FIG. 1A employing SKIPPER-FRET in accordance with aspects of the present disclosure;

FIG. 2A is a diagram showing a conditional dependency model for variables to be inferred by the system of FIGS. 1A and 1B (e.g., energy potential landscape, friction coefficient, and excitation rate) with respect to observable smFRET data (red and green photon counts corresponding to donor and acceptor fluorophores shown in FIG. 1A) in accordance with aspects of the present disclosure, and FIG. 2B is a diagram showing a SKI-GP process that reduces computational complexity of evaluating the energy potential landscape;

FIGS. 3A and 3B are graphical representations showing observed photon count data correlating with inferred pair fluorophore distance trajectories inferred by the system of FIG. 1A2B, as well as a ground truth, in accordance with aspects of the present disclosure;

FIG. 4 is a graphical representation showing a potential energy landscape for the data of FIG. 3A inferred by the system of FIG. 1A2B compared with a ground truth potential energy landscape and corresponding states inferred by an HMM method in accordance with aspects of the present disclosure;

FIG. 5 is a graphical representation showing a potential energy landscape inferred by the system of FIG. 1A2B when one barrier is far from the characteristic FRET range, compared with a ground truth potential energy landscape and corresponding states inferred by an HMM method in accordance with aspects of the present disclosure;

FIGS. 6A and 6B are graphical representations showing observed photon count data of a NCBD-ACTR binding experiment correlating with inferred pair fluorophore distance trajectories inferred by the system of FIG. 1A2B, as well as a ground truth, in accordance with aspects of the present disclosure;

FIG. 7 is a graphical representation showing a potential energy landscape for the data of FIG. 6A inferred by the system of FIG. 1A2B compared with a ground truth potential energy landscape and corresponding states inferred by an HMM method in accordance with aspects of the present disclosure;

FIGS. 8A-8E are a series of graphical representations showing results of a robustness test with respect to number of data points, where each panel plots a potential energy landscape inferred using SKIPPER-FRET against a ground truth potential energy landscape for a given number of measurements in accordance with aspects of the present disclosure;

FIG. 9 is a graphical representation showing a potential energy landscape with a “sharp dip” inferred by the system of FIG. 1A2B compared with a ground truth potential energy landscape and corresponding states inferred by an HMM method in accordance with aspects of the present disclosure;

FIG. 10 is a graphical representation showing a potential energy landscape inferred by the system of FIG. 1A2B with the “sharp dip” of FIG. 9 but with a small length scale, compared with a ground truth potential energy landscape and corresponding states inferred by an HMM method in accordance with aspects of the present disclosure;

FIG. 11 is a diagram showing an exemplary computing system for implementation of the system of FIGS. 1A-2B in accordance with aspects of the present disclosure; and

FIGS. 12A and 12B are a pair of process flow diagrams showing an example method/process associated with the system of FIGS. 1A-2B in accordance with aspects of the present disclosure.

Corresponding reference characters indicate corresponding elements among the view of the drawings. The headings used in the figures do not limit the scope of the claims.

### DETAILED DESCRIPTION

### 1. Introduction

Potential energy landscapes are useful continuous space model reductions employed across biophysics. For example, potentials can model dynamics along smooth reaction coordinates including the celebrated protein folding funnel. They also provide a natural language from which to calculate thermodynamic quantities. Furthermore, shapes of landscapes, including barrier heights and friction coefficients, can provide insight into molecular function such as molecular motor dynamics. As such, inferring accurate potentials is a crucial step towards gaining insight into biophysical systems.

One way by which to decode potential energy landscapes from biological systems is through single molecule Fluorescence Resonance Energy Transfer (smFRET) experiments. Most commonly, smFRET works by tagging two locations of a biomolecule with pairs of fluorophores. When in proximity, the fluorophore excited by the laser (the donor) may transfer its excitation, via dipole-dipole coupling, over to the acceptor fluorophore. As the distance between the donor and acceptor fluorophores change, so too does the efficiency of dipole-dipole energy transfer resulting in higher donor emission rates when fluorophores are further apart. Conversely, more photons are emitted from the acceptor when fluorophores are in close proximity. As such, it is common to use the proportion of donor and acceptor photons counted in a given time window, the FRET efficiency, to estimate the pair fluorophore distance.

To deduce energies from smFRET data it is common to immediately assume a discrete state-space and invoke Hidden Markov Models (HMMs) in the ensuing analysis. HMMs work by partitioning the observed smFRET efficiencies into discrete levels coinciding with distinct states. One can then use smFRET data to infer the number of states in addition to the associated transition rate parameters and pair distances, which in turn can be used to infer the potential energy of the states using the Boltzmann distribution.

The above approach is useful in gaining quantitative insight into systems well approximated by discrete states. However, the above formulation is not appropriate when the dynamics occur along a continuous reaction coordinate poorly approximated by well separated discrete-states.

Furthermore, while HMMs can be used to infer each state's relative energies (though parametric HMMs require a specification in the number of states), they cannot reveal energy barriers between states without preexisting knowledge of internal system parameters, such as the landscape curvature and internal friction, due to loss of information inherent to the discretization process. The inability to infer accurate potential energy barriers from a single data set without the knowledge of hidden internal parameters is an important limitation of HMMs applied to smFRET data. Furthermore, analyzing a continuous system with discrete states may introduce important biases in the expected distances defining the FRET states.

As such, a method capable of inferring potential energy landscapes, including barrier heights and friction coefficients, along a continuous coordinate would greatly enhance the resolution for probing biophysical systems and lend deeper insight into protein folding, protein binding, and the physics of molecular motors.

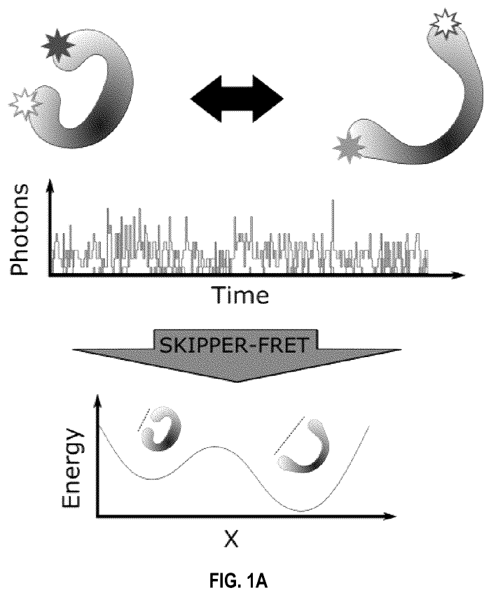

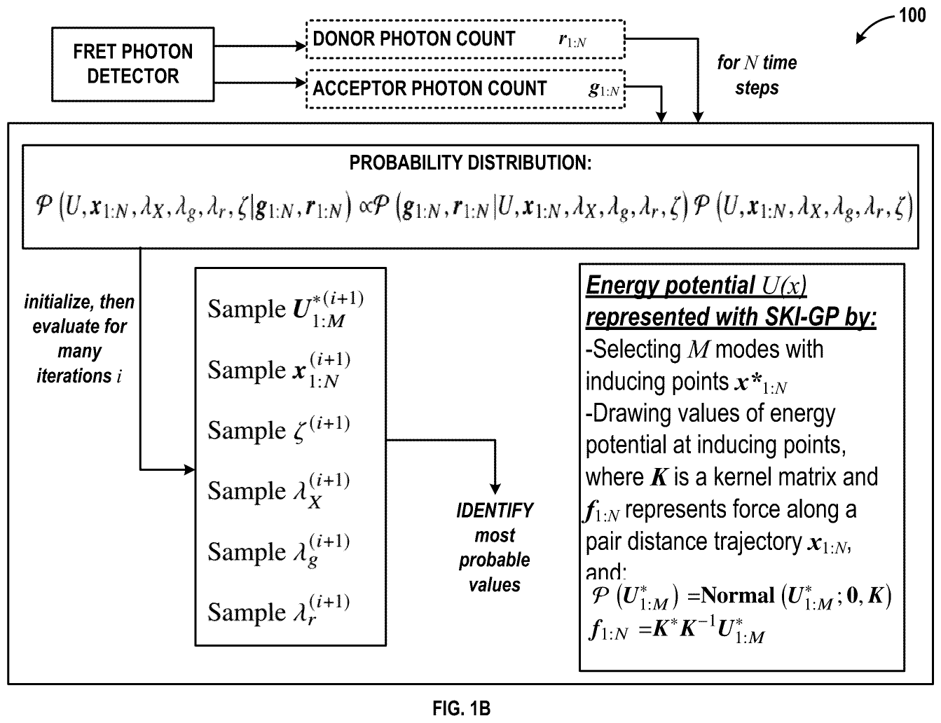

The present disclosure outlines a system (e.g., “system 100” shown in FIGS. 1A and 1B) and associated methods to decode a continuous potential from smFRET data without resorting to discrete state-space assumptions inherent to HMM modeling. A method implemented by the system 100 may include incorporating a detailed, physics-informed likelihood distribution describing a relationship between measurements and a potential energy landscape. The method may further include inferring a probable potential energy landscape within a Bayesian nonparametric paradigm by placing a prior on the potential energy landscape with support over the family of all putative continuous curves. The prior distribution on the potential energy landscape may be built upon a Structured-Kernel-Interpolation Gaussian-Process, which allows for inference of continuous potentials while simultaneously avoiding the costly cubic scaling of conventional Gaussian-Process regression. Cubic scaling becomes especially problematic when incorporating realistic measurement features into a likelihood distribution.

The present disclosure shows that Structure-Kernel-Interpolation Priors for Potential Energy Reconstruction from smFRET (SKIPPER-FRET) analysis unveils the full potential energy landscape, including barrier heights and friction coefficients within reasonable computational time. System 100 outlined herein (also referred to as “SKIPPER-FRET”) is described in in FIG. 1A, which shows a protein switching between two conformations over time. The protein is labeled with a donor and an acceptor fluorophore. As the protein changes configuration, the FRET efficiency between the fluorophores also changes. Below the image of the protein, FIG. 1A illustrates a typical trace containing the number of red and green photons over time that can be used as input to SKIPPER-FRET. The bottom panel shows an example outcome of SKIPPER-FRET analysis used to infer a potential energy landscape along the reaction coordinate probed.

FIG. 1B shows a computational scheme of the system 100 (SKIPPER-FRET). SKIPPER-FRET is benchmarked on synthetic/simulated data as well as experimental data.

Unless defined otherwise, all technical and scientific terms used herein have the same meaning as commonly understood by one of ordinary skill in the art to which the invention pertains. All definitions, as defined and used herein, should be understood to control over dictionary definitions, definitions in documents incorporated by reference, and/or ordinary meanings of the defined terms.

All references, patents and patent applications disclosed herein are incorporated by reference with respect to the subject matter for which each is cited, which in some cases may encompass the entirety of the document.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein, the terms “approximately” or “about” in reference to a number are generally taken to include numbers that fall within a range of 5% in either direction (greater than or less than) the number unless otherwise stated or otherwise evident from the context (except where such number would exceed 100% of a possible value). Where ranges are stated, the endpoints are included within the range unless otherwise stated or otherwise evident from the context.

The present invention has been described in terms of one or more preferred embodiments, and it should be appreciated that many equivalents, alternatives, variations, and modifications, aside from those expressly stated, are possible and within the scope of the invention.

### 2. Materials and Methods

One goal of the system 100 is to learn potentials given photon arrival data from two channels assuming continuous illumination smFRET data. Generalization to pulsed data is possible and as described above and herein in. In some embodiments, generalization to pulsed data is possible as described in “Materials and Methods” section 2.6 of the present disclosure. In the present disclosure, a forward model is provided describing how a potential gives rise to data collected by a FRET photon detector. Additionally, in the present disclosure, an inverse model is provided that enables inferring the potential directly from data along with a numerical algorithm developed to sample from a resulting high dimensional posterior. Furthermore, in the present disclosure a validation study is summarized for evaluation of the methods outlined herein.

### 2.1-Forward Model

For implementation of the system 100, donor and acceptor fluorophores are placed at two points whose relative distance varies with time. That is, the system 100 can be implemented for either monitoring a molecule undergoing configurational changes along a reaction coordinate or a pair of molecules binding and unbinding; the formulations outlined herein are applicable in either case. The dynamics of the probes with respect to each other are dictated by a potential (e.g., energy potential) to be deduced. A labeled biological system is exposed to continuous illumination in which both fluorophores will be excited. Donor excitations have a position dependent probability of FRET transfer, whereas acceptor excitations are treated as a source of background. This section describes this process in detail.

### 2.2-Pair Distance

Beginning with the assumption that the distance of interest evolves according to Langevin dynamics:

$$ζ \frac{dx}{dt} = f ( x ) + r ( t ) \qquad ( 1 )$$

with unknown constant ζ (the friction coefficient) and unknown spatially dependent force (f=−∇U). In the above, r(t) is the thermal noise whose moments read:

$$〈 r ( t ) 〉 = 0 \qquad ( 2 )$$

$$〈 r ( t ) r ( {t}^{′} ) 〉 = 2 ζ kT δ ( t - {t}^{′} ) . \qquad ( 3 )$$

Here kT is the usual thermal energy and [symbol] . . . [symbol] denotes an average over thermal noise realizations. Note that for this disclosure, a friction coefficient is assumed to be constant.

Under the Ito approximation, equation 1 can be evaluated on a fine grid of time levels,

$$\frac{ζ}{Δ t} ( {x}_{n + 1} - {x}_{n} ) = f ( {x}_{n} ) + \sqrt{\frac{2 ζ kT}{Δ t}} {ϵ}_{n} \qquad ( 4 )$$

where xₙ is the distance at time level n, Δt is the time step size, and ϵₙ is a normally distributed random variable with mean 0 and variance 1. The probability of xₙ₊₁ can be rewritten as follows:

$$𝒫 ( {x}_{n + 1} \vert {x}_{n} , ζ , U ) = Normal ( {x}_{n + I} ; {x}_{n} + \frac{Δ t}{ζ} f ( {x}_{n} ) , \frac{2 Δ tkT}{ζ} ) \qquad ( 5 )$$

which reads “the probability of xₙ₊₁ given ζ, U and the previous position (xₙ) is a Normal distribution with mean

$${x}_{n} + \frac{Δ t}{ζ} f ( {x}_{n} )$$

and variance

$$\frac{2 Δ {tkT}_{″}}{ζ} ,$$

Here, let N be the number of time levels and let x_{1:N} represent the set of all positions at those time levels (i.e., a trajectory). Note that the time step, Δt, must be chosen to be small enough that the Ito approximation be valid but, in principle, need not coincide with the measurement time scale.

Another important note is in order. When analyzing data from binding experiments, it is envisioned that the FRET setup involves a donor-tagged immobilized biomolecule interacting with an acceptor-tagged binding agent. In this setup, the pair fluorophore distance, x, as a distance between the donor fluorophore and the nearest acceptor fluorophore with the understanding that the identity of the acceptor fluorophore may change over time.

### 2.3-Photon Measurements

To model photon counts, a number of physically reasonable assumptions are made for the purposes of the present disclosure. First, it is assumed that time scales over which pair distances vary are much slower than fluorophore excited state relaxation times (microseconds or slower versus nanoseconds). Secondly, it is assumed that the small absorption cross section of the fluorophores results in a low excitation rate compared with the relaxation rate. Thus, the interphoton arrival time is dominated by the excitation rate, λ_{X}.

As the pair distance is assumed to remain constant over the whole time step (see equation 5), the FRET rate will also be assumed constant (with changes approximated as occurring when time levels change). Thus, photon arrival times and the order of photon colors within a time step provide no additional information. In this regime, the probability of the number of measured green, gₙ, and red, rₙ, photons are drawn from a Poisson distribution (see section 5.1 of the present disclosure).

$$𝒫 ( {g}_{n} ) = Poisson ( {g}_{n} ; Δ {tD}_{g} ( {λ}_{X} {f}_{g} ( {x}_{n} ) + {λ}_{g} ) ) \qquad ( 6 )$$

$$𝒫 ( {r}_{n} ) = Poisson ( {r}_{n} ; Δ {tD}_{r} ( {λ}_{X} {f}_{r} ( {x}_{n} ) + {λ}_{r} ) ) \qquad ( 7 )$$

where λ_{X} is the donor excitation rate, λ_{g} is the green photon background rate, λᵣ is the red photon background rate (which includes the direct acceptor excitation rate), D_{g} and Dᵣ are detector efficiencies, and f_{g}(xₙ) and fᵣ(xₙ) are the fraction of photons emitted by the FRET pair detected in the green and red channel, respectively, calculated from the FRET efficiency as a function of position, FRET(x). The crosstalk matrix, which encodes the efficiency at which a red photon is measured to be green and vice versa, reads as follows:

$$FRET ( x ) = \frac{1}{1 + {( \frac{x}{{R}_{0}} )}^{6}} \qquad ( 8 )$$

$$[ \begin{matrix}{f}_{g} ( x ) \\ {f}_{r} ( x )\end{matrix} ] = [ \begin{matrix}{C}_{gg} & {C}_{gr} \\ {C}_{rg} & {C}_{rr}\end{matrix} ] [ \begin{matrix}1 - FRET ( x ) \\ FRET ( x )\end{matrix} ] \qquad ( 9 )$$

where R₀ is the characteristic distance for the acceptor donor pair at which the FRET efficiency is 0.5 and Cᵢⱼ is the probability that a photon with color i is detected by detector j. For example, C_{rg} is the probability that a red photon is detected by the green photon detector.

### 2.4-Inverse Model

One goal of the system 100 outlined herein is to create a probability distribution for the potential energy landscape, U(x), the pair distance trajectory, x_{1:N}, the excitation rate, λ_{X}, the background photon rates, λᵣ and λ_{g}, and the friction coefficient, ζ, given a series of photon measurements, g_{1:N} and r_{1:N}. Note that detector efficiencies, D_{g} and Dᵣ, and the crosstalk matrix can be calibrated separately and therefore do not need to be inferred.

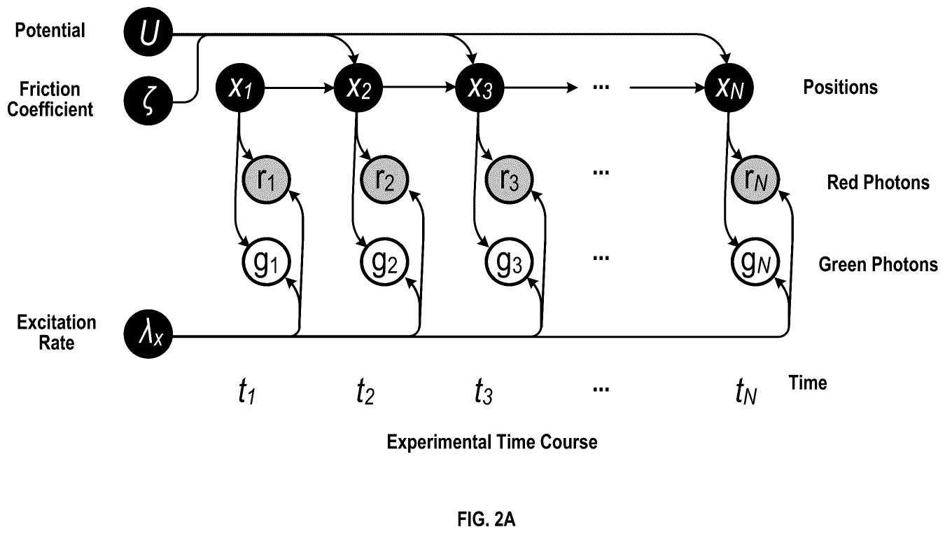

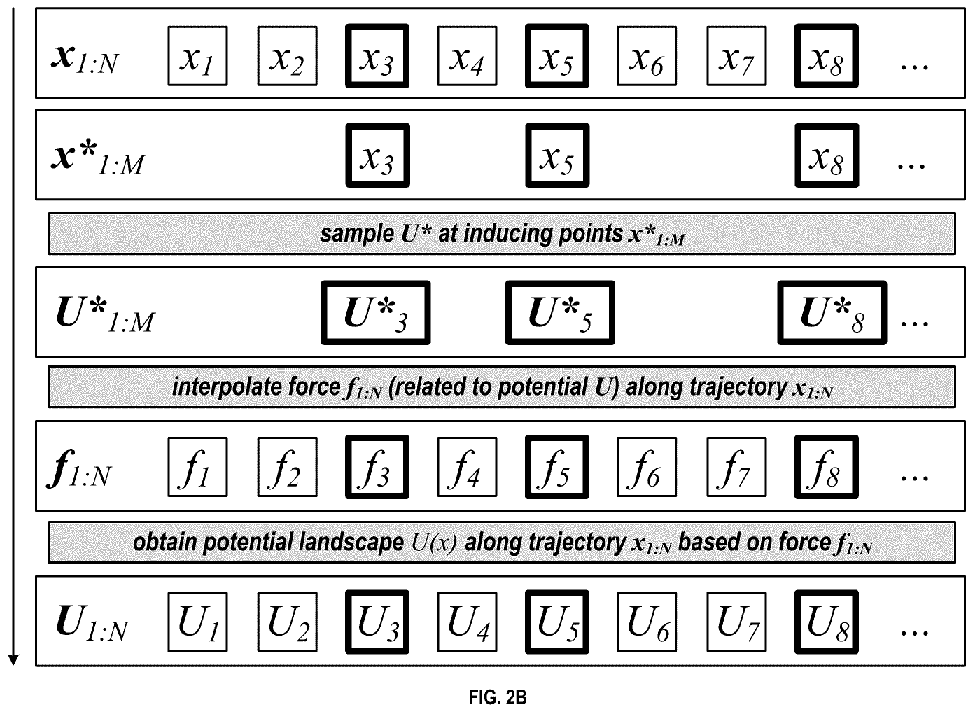

FIG. 2A shows a graphical model of the full posterior used by the system 100 to measure the potential energy landscape, U(x), the pair distance trajectory, x_{1:N}, the excitation rate, λ_{X}, the background photon rates, λᵣ and λ_{g}, and the friction coefficient, ζ, given the series of photon measurements, g_{1:N} and r_{1:N}, illustrating the conditional dependence of all variables. In FIG. 2A, nodes (circles) represent random variables of the model while arrows connecting the nodes highlight conditional dependencies. Black nodes represent variables to be inferred within the inference scheme outlined herein, and the gray and white nodes represent the measured photon counts for each bin (corresponding to red photon counts and green photon counts).

Using Bayes' theorem:

$$𝒫 ( U , {x}_{1 : N} , {λ}_{X} , {λ}_{g} , {λ}_{r} , ζ \vert {g}_{1 : N} , {r}_{1 : N} ) ∝ 𝒫 ( {g}_{1 : N} , {r}_{1 : N} \vert U , {x}_{1 : N} , {λ}_{X} , {λ}_{g} , {λ}_{r} , ζ ) 𝒫 ( U , {x}_{1 : N} , {λ}_{X} , {λ}_{g} , {λ}_{r} , ζ ) . \qquad ( 10 )$$

The first term on the right side of equation 10 is called the likelihood and is equal to the product of equations 6 and 7 for each time level. The second term is called the prior and can further be decomposed as follows:

$$𝒫 ( U , {x}_{1 : N} , {λ}_{X} , {λ}_{g} , {λ}_{r} , ζ ) = ( {\prod }_{n = 2}^{N} 𝒫 ( {x}_{n} \vert {x}_{n - 1} U , ζ ) ) 𝒫 ( {x}_{1} ) 𝒫 ( U ) 𝒫 ( ζ ) 𝒫 ( {λ}_{X} ) 𝒫 ( {λ}_{g} ) 𝒫 ( {λ}_{r} ) . \qquad ( 11 )$$

The first term on the right hand side, [symbol] (xₙ|xₙ₋₁U,ζ), is the discretized Langevin equation (equation 5). The remaining priors over [symbol] (x₁), [symbol] (U), [symbol] (ζ), [symbol] (λ_{X}), [symbol] (λ_{g}), and [symbol] (λᵣ) can further be selected.

The discussion starts by placing priors on photon rates and friction coefficient. The excitation rate, λ_{X}, is strictly positive and, as such, an acceptable choice of prior is the Gamma distribution which has nonzero probability density along the positive real line

$$𝒫 ( {λ}_{X} ) = Gamma ( {λ}_{X} ; {κ}_{{λ}_{X}} , {θ}_{{λ}_{X}} ) \qquad ( 12 )$$

where κ_{λ}_{_{X}}=2 is chosen to make the mode of the distribution diffuse (i.e., create an uninformative prior), and θ_{λ}_{_{X}} is chosen to give a mean expected value close to the average number of observed photons per frame. Similarly, a Gamma prior on can be placed on the background photon rates,

$$𝒫 ( {λ}_{r} ) = Gamma ( {λ}_{r} ; {κ}_{prior : {λ}_{r}} , {θ}_{{λ}_{r}} ) \qquad ( 13 )$$

$$𝒫 ( {λ}_{g} ) = Gamma ( {λ}_{g} ; {κ}_{prior : {λ}_{g}} , {θ}_{{λ}_{g}} ) \qquad ( 14 )$$

where κ_{λ}_{ᵣ}=κ_{λ}_{_{g}}=2 and values for θ_{λ}_{ᵣ} and θ_{λ}_{ᵣ} give mean values close to the measured background rates. Similarly, because ζ is strictly positive, the Gamma distribution is also a good choice. The prior over the friction coefficient can be:

$$𝒫 ( ζ ) = Gamma ( ζ ; {κ}_{ζ} , {θ}_{ζ} ) \qquad ( 15 )$$

where κ_{ζ}=2 and θ_{ζ}=5000 ag/ns are chosen to be minimally informative. In other words, κ_{ζ} and θ_{ζ} are selected such that the resulting prior is broad over a physically motivated region, Note that κ_{λ}_{ₓ}, θ_{λ}_{_{X}}, κ_{λ}_{_{g}}, θ_{λ}_{_{g}}, κ_{λ}_{ᵣ}, θ_{λ}_{ᵣ}, κ_{λ}_{_{ζ}}, and θ_{λ}_{_{ζ}} are hyperparameters whose exact values bear little weight on the final form of the posterior as more data are acquired.

A prior can also be placed on the initial position (e.g., the position of the donor fluorophore or acceptor fluorophore). That is, under the dynamics model of equation 5, subsequent positions, x_{2:N}, are directly conditioned on the previous position, i.e., the dynamics follow a Markov chain. As such, a prior need only be placed on the position at the first time step, x₁. For computational reasons, a Normal distribution was selected for implementation as the prior over x₁ as it matches the form of the transition probability of equation 5,

$$𝒫 ( {x}_{1} ) = Normal ( {x}_{1} ; {R}_{0} , {R}_{0}^{2} ) \qquad ( 16 )$$

As the initial position is known to be around the characteristic FRET distance up to some uncertainty, it is convenient to set the distribution at R₀ with standard deviation R₀. The latter choices are immaterial in the presence of sufficient data.

The choice of prior on potential energy landscape, U(x), is of particular importance. One natural prior choice is the Gaussian process, which enables to sampling from all putative curves without the need to pre-specify any functional form. However, a naive implementation of the Gaussian process is computationally intractable for large data sets as computational complexity scales cubically with the size of the data. This is especially challenging given the lack of conjugacy between the likelihood and prior rendering direct sampling of the posterior infeasible.

Instead, the present disclosure outlines a computationally efficient adaptation of the Gaussian process leveraging recent advances in structured-kernel-interpolation Gaussian processes (SKI-GP). Briefly, SKI-GPs work by selecting a set of M nodes x*_{1:M}, termed inducing points, from the trajectory x_{1:N} where the potential needs to be evaluated exactly. FIG. 2B is an illustration showing this process. The value of the potential at the inducing points is itself drawn from a zero mean multivariate Normal distribution with some pre-specified covariance matrix,

$$𝒫 ( {U}_{1 : M}^{*} ) = Normal ( {U}_{1 : M}^{*} ; 0 , K ) \qquad ( 17 )$$

where K is a kernel matrix with elements Kᵢⱼ=k(xᵢ*,xⱼ*) where k is a kernel function defined by,

$$k ( x , y ) = {h}^{2} exp ( - \frac{{( x - y )}^{2}}{2 {ℓ}^{2}} ) \qquad ( 18 )$$

where h and [symbol] are hyperparameters setting the prior uncertainty and length scale respectively and x and y are two arbitrary arguments. The values of the potential can then be interpolated elsewhere. For example, collecting force evaluated along the trajectory (see equation 1) into a vector, f_{1:N}, and collecting the potential evaluated at the inducing points into a vector, U*_{1:M}, the remaining values of the force represented by f_{1:N} and potential represented by U*_{1:M} at any point along the trajectory x_{1:N} can be interpolated using:

$${f}_{1 : N} = {K}^{*} {K}^{- 1} {U}_{1 : M}^{*} \qquad ( 19 )$$

where K*, with elements Kₙₘ*=−∇k(xₙ,xₘ*), is the kernel matrix between the force at each point in the trajectory and the potential at the inducing points. Note that potential is considered an integral of force, as such, the potential landscape U(x) (or U_{1:N} in its discrete form) can be related to the force vector f_{1:N} through integration.

Putting together all distributions and priors of the above-outlined model, a posterior for SKIPPER-FRET is attained:

$$( 20 )$$

$$\begin{matrix}\begin{matrix}𝒫 ( {U}_{1 : M}^{*} , {x}_{1 : N} , ζ , {λ}_{X} , \\ {λ}_{g} , {λ}_{r} \vert {r}_{1 : N} , {g}_{1 : N} )\end{matrix} ∝ Normal ( {U}_{1 : M}^{*} ; 0 , K ) Gamma ( ζ ; {κ}_{ζ} , {θ}_{ζ} ) \\ \times Gamma ( {λ}_{X} ; {κ}_{{λ}_{X}} , {θ}_{{λ}_{X}} ) Gamma ( {λ}_{r} ; {κ}_{{λ}_{r}} , {θ}_{{λ}_{r}} ) \\ Gamma ( {λ}_{g} ; {κ}_{{λ}_{g}} , {θ}_{{λ}_{g}} ) \\ \times Normal ( {x}_{1} ; {R}_{0} , {R}_{0}^{2} ) {\prod }_{N - 1}^{N - 1} Normal ( {x}_{n + 1} ; {x}_{n} + \\ \frac{Δ t}{ζ} f ( {x}_{n} ) , \frac{2 Δ tkT}{ζ} ) \\ \times {\prod }_{N - 1}^{N} Poisson ( {g}_{n} ; Δ {tD}_{g} ( {λ}_{X} {f}_{g} ( {x}_{n} ) + {λ}_{g} ) ) \\ Poisson ( {r}_{n} ; Δ {tD}_{r} ( {λ}_{X} {f}_{r} ( {x}_{n} ) + {λ}_{r} ) ) .\end{matrix}$$

### 2.5-Algorithm

The inverse model results in a high-dimensional posterior, equation (20), which does not attain an analytical form and cannot be directly sampled. Thus, the present disclosure outlines a method for drawing samples from the posterior in equation (20) using an overall Gibbs sampling scheme.

Gibbs sampling works by starting from an initial guess for the parameters, then iteratively sampling each variable while holding other variables fixed. This scheme, where superscripts indicate the iteration index, is outlined below:
Step 1: Start with an initial guess for each variable:
   U*_{1:M}⁽⁰⁾,x_{1:N}⁽⁰⁾,ζ⁽⁰⁾,λ_{X}⁽⁰⁾,λ_{g}⁽⁰⁾, and λᵣ⁽⁰⁾.
Step 2: For many iterations i,
   Sample U*_{1:M}⁽ⁱ⁺¹⁾ from [symbol] (U*_{1:M}|x_{1:N}⁽ⁱ⁾,ζ⁽ⁱ⁾,λ_{X}⁽ⁱ⁾,λ_{g}⁽ⁱ⁾,λᵣ⁽ⁱ⁾,r_{1:N},g_{1:N}).
   Sample x_{1:N}⁽ⁱ⁺¹⁾ from [symbol] (x_{1:N}|U*_{1:M}⁽ⁱ⁺¹⁾,ζ⁽ⁱ⁾,λ_{X}⁽ⁱ⁾,λ_{g}⁽ⁱ⁾,λᵣ⁽ⁱ⁾,r_{1:N},g_{1:N}).
   Sample ζ⁽ⁱ⁺¹⁾ from [symbol] (ζ|U*_{1:M}⁽ⁱ⁺¹⁾,x_{1:N}⁽ⁱ⁺¹⁾,λ_{X}⁽ⁱ⁾,λ_{g}⁽ⁱ⁾,λᵣ⁽ⁱ⁾,r_{1:N},g_{1:N}).
   Sample λ_{X}⁽ⁱ⁺¹⁾ from [symbol] (λ_{X}|U*_{1:M}⁽ⁱ⁺¹⁾,x_{1:N}⁽ⁱ⁺¹⁾,ζ⁽ⁱ⁺¹⁾,λ_{g}⁽ⁱ⁾,λᵣ⁽ⁱ⁾,r_{1:N},g_{1:N}).
   Sample λ_{g}⁽ⁱ⁺¹⁾ from [symbol] (λ_{g}|U*_{1:M}⁽ⁱ⁺¹⁾,x_{1:N}⁽ⁱ⁺¹⁾,ζ⁽ⁱ⁺¹⁾,λ_{X}⁽ⁱ⁺¹⁾,λᵣ⁽ⁱ⁾,r_{1:N},g_{1:N}).
   Sample λᵣ⁽ⁱ⁺¹⁾ from [symbol] (λᵣ|U*_{1:M}⁽ⁱ⁺¹⁾,x_{1:N}⁽ⁱ⁺¹⁾,ζ⁽ⁱ⁺¹⁾,λ_{X}⁽ⁱ⁺¹⁾,λ_{g}⁽ⁱ⁺¹⁾,r_{1:N},g_{1:N}).

The conditional probabilities for each variable sampled in Step 2 above are outlined in sections 2.7-2.12 of the present disclosure. Once sufficient samples have been generated (after burn-in is discarded), an average of the samples and other metrics can be used for further analysis, including determining point estimates for the estimated values of each variable or plotting the distribution of all samples drawn.

### 2.6-Data Acquisition

The validation study outlined herein involves single photon smFRET data taken from an experiment probing the binding between the nuclear-coactivator binding domain (NCBD) of the CBP/p300 transcription factor and the activation domain of SRC-3 (ACTR). ACTR and NCBD are both intrinsically disordered proteins. In the experiment, ACTR is surface immobilized and labeled with a donor dye (Cy3B). A solution including acceptor (CF660R) labeled NCBD is added. To probe the binding coordinate, donor and acceptor photons are collected as the NCBD binds and unbinds to ACTR. The analysis provided herein reveals the binding energy landscape of the ACTR-NCBD complex.

### 2.7-Derivation of the Likelihood

This section shows derivation of the likelihood distribution for observing photon measurements given particle positions. One important consequence of the Ito approximation pertaining to equation 5, is that the likelihood for single photon data will be equivalent to the likelihood for binned data. That is to say that neither photon arrival times nor ordering of photon colors within a time window provide any additional information about the particle position. This section starts by deriving the likelihood for single photon measurements. After showing that the single photon measurements contain no additional information here as compared to binned photon measurements, derivation is shown for the likelihood for binned photons (equations 6 and 7) used throughout this work.

The probability of collecting J photons with photon arrival times, T, and photon colors, ϕ, within a time window can be written as:

$$𝒫 ( T , ϕ \vert x , {λ}_{X} , {λ}_{g} , {λ}_{r} ) = 𝒫 ( T \vert x , {λ}_{X} , {λ}_{g} , {λ}_{r} ) 𝒫 ( ϕ \vert T , x , {λ}_{X} , {λ}_{g} , {λ}_{r} ) \qquad ( s1 )$$

where, for simplicity alone, the derivation outlined here ignores artifacts induced by crosstalk and detector efficiency (discussed in equations 6-9 herein). The time between photon arrivals will be exponentially distributed according to the excitation rate, λ_{X}, and the background rates, λ_{g} and λᵣ. The probability of the photon arrival times, T, is the probability of the J inter-photon times multiplied by the probability of having no photon following the J-th photon,

$$𝒫 ( T \vert x , {λ}_{X} , {λ}_{g} , {λ}_{r} ) ∝ ( 1 - {\int }_{0}^{Δ t - {T}_{J}} dt Exp ( t ; {λ}_{X} + {λ}_{g} + {λ}_{r} ) ) {\prod }_{j = 1}^{J} Exp ( {T}_{j} - {T}_{j - 1} ; {λ}_{X} + {λ}_{g} + {λ}_{r} ) \qquad ( s2 )$$

$$= {{e}^{- ( {λ}_{X} + {λ}_{g} + {λ}_{r} ) ( Δ t - {T}_{J} )} ( {λ}_{X} + {λ}_{g} + {λ}_{r} )}^{J} {e}^{- ( {λ}_{X} + {λ}_{g} + {λ}_{r} ) {\sum }_{j = 1}^{J} {T}_{j} - {T}_{j - 1} )} \qquad ( s3 )$$

$$= {( {λ}_{X} + {λ}_{g} + {λ}_{r} )}^{J} {e}^{- ( {λ}_{X} + {λ}_{g} + {λ}_{r} ) Δ t} \qquad ( s4 )$$

where in the derivation T₀=0. The probability over the photon colors is the product of the probabilities over each individual photon given by the rates and the FRET efficiency,

$$𝒫 ( ϕ \vert T , x , {λ}_{X} , {λ}_{g} , {λ}_{r} ) ∝ {\prod }_{j = 1}^{J} \frac{{( {λ}_{X} {f}_{g} ( x ) + {λ}_{g} )}^{[ {ϕ}_{j} = green ]} {( {λ}_{X} {f}_{r} ( x ) + {λ}_{r} )}^{[ {ϕ}_{j} = red ]}}{{λ}_{X} + {λ}_{g} + {λ}_{r}} \qquad ( s5 )$$

$$= \frac{{( {λ}_{X} {f}_{g} ( x ) + {λ}_{g} )}^{G} {( {λ}_{X} {f}_{r} ( x ) + {λ}_{r} )}^{R}}{{( {λ}_{X} + {λ}_{g} + {λ}_{r} )}^{J}} \qquad ( s6 )$$

where f_{g}(x)=1−FRET(x), fᵣ(x)=FRET(x), [x=y] is the Iverson bracket (which is equal to 1 if x=y and 0 otherwise), and R and G are the total number of observed red and green photons. Putting this all together yields a distribution which has no dependency on individual photon arrival times nor photon color order,

$$𝒫 ( T , ϕ \vert x , {λ}_{X} , {λ}_{g} , {λ}_{r} ) ∝ {( {λ}_{X} {f}_{g} ( x ) + {λ}_{g} )}^{G} {( {λ}_{X} {f}_{r} ( x ) + {λ}_{r} )}^{R} {e}^{- Δ t ( {λ}_{X} + {λ}_{g} + {λ}_{r} )} . \qquad ( s7 )$$

Since the likelihood depends neither on individual photon arrival times nor on photon color ordering, no generality is lost by rewriting the likelihood solely in terms of the number of measured photons within a time bin.

The likelihood can further be derived for measuring R red photons and G green photons in a time window. The probability of collecting G green photons and R red photons in a time window is the probability of collecting J=G+R photons multiplied by the probability that R of the photons are red,

$$𝒫 ( R , G \vert {λ}_{X} , {λ}_{g} , {λ}_{r} , x ) = 𝒫 ( R \vert J , {λ}_{X} , {λ}_{g} , {λ}_{r} , x ) 𝒫 ( J \vert {λ}_{X} , {λ}_{g} , {λ}_{r} ) . \qquad ( s8 )$$

The probability of collecting/photons in a time window is Poisson distributed according to the rates,

$$𝒫 ( J \vert {λ}_{X} , {λ}_{g} , {λ}_{r} ) = Poisson ( J ; Δ t ( {λ}_{X} + {λ}_{g} + {λ}_{r} ) ) . \qquad ( s9 )$$

The probability that R photons are red is a binomial distribution with weight given by the relative rates of red and green photons

$$𝒫 ( R \vert J , {λ}_{X} , {λ}_{g} , {λ}_{r} , x ) = Binomial ( R ; \frac{{λ}_{X} {f}_{r} ( x ) + {λ}_{r}}{{λ}_{X} + {λ}_{g} + {λ}_{r}} , R + G ) . \qquad ( s10 )$$

All together this yields

$$𝒫 ( G , R \vert {λ}_{X} , {λ}_{r} , {λ}_{g} , x ) = Binomial ( R ; \frac{{λ}_{X} {f}_{r} ( x ) + {λ}_{r}}{{λ}_{x} + {λ}_{g} + {λ}_{r}} ) Poisson ( J ; Δ t ( {λ}_{X} + {λ}_{g} + {λ}_{r} ) ) \qquad ( s11 )$$

$$= ( \begin{matrix}G + R \\ R\end{matrix} ) {( \frac{{λ}_{X} {f}_{r} ( x ) + {λ}_{r}}{{λ}_{x} + {λ}_{g} + {λ}_{r}} )}^{R} {( 1 - \frac{{λ}_{X} {f}_{r} ( x ) + {λ}_{g}}{{λ}_{X} + {λ}_{g} + {λ}_{r}} )}^{G} \frac{{( Δ t ( {λ}_{X} + {λ}_{r} + {λ}_{g} ) )}^{R + G}}{( R + G ) !} {e}^{- Δ t ( {λ}_{X} + {λ}_{r} + {λ}_{g} )} \qquad ( s12 )$$

$$( s13 )$$

$$= \frac{{( Δ t ( {λ}_{X} {f}_{r} ( x ) + {λ}_{r} ) )}^{R}}{R !} {e}^{- Δ t ( {λ}_{X} {f}_{r} ( x ) + {λ}_{r} )} \frac{{( Δ t ( {λ}_{X} {f}_{g} ( x ) + {λ}_{g} ) )}^{G}}{G !} {e}^{- Δ t ( {λ}_{X} {f}_{g} ( x ) + {λ}_{g} )}$$

$$= Poisson ( R ; Δ t ( {λ}_{X} {f}_{r} ( x ) + {λ}_{r} ) ) Poisson ( G ; Δ t ( {λ}_{X} {f}_{g} ( x ) + {λ}_{g} ) ) . \qquad ( s14 )$$

This is the likelihood (equations 6 and 7) used throughout this work.

### 2.8-Conditional Probabilities

This section derives the conditional probabilities used in the Gibbs sampling algorithm of section 2.3 of the present disclosure. Note that, for clarity, this section omits multiplicative terms not directly related to the variable conditioned on in each of the following equations. This is done because these terms are treated as constants during each step of the conditional sampling in the Gibbs sampler.

### 2.9-Positions

The distribution over positions is the product of the likelihood (equations 6 and 7), the discretized Langevin equation (equation 5), and the prior on the initial position (equation 16)

$$\begin{matrix}\begin{matrix}𝒫 ( {x}_{1 : N} \vert {U}_{1 : M}^{*} , ζ , {λ}_{X} , \\ {λ}_{g} , {λ}_{r} , {g}_{1 : N} , {r}_{1 : N} )\end{matrix} & ∝ & 𝒫 ( {g}_{1 : N} \vert {x}_{1 : N} ) 𝒫 ( {r}_{1 : N} \vert {x}_{1 : N} ) & ( s15 ) \\ & & 𝒫 ( x \vert {U}_{1 : M}^{*} , ζ , {λ}_{X} ) & \\ & = & Normal ( {x}_{1} ; R 0 , R {0}^{2} ) & \\ & \times & ( {\prod }_{n = 2}^{N} Normal ( {x}_{n} ; {x}_{n - 1} + & \\ & & \frac{Δ t}{ζ} f ( {x}_{n - 1} ) , \frac{2 Δ tkT}{ζ} ) & \\ & \times & ( {\prod }_{n - 1}^{N} Poisson ( {g}_{n} ; {λ}_{X} ( 1 - FRET ( {x}_{n} ) ) + {λ}_{g} ) ) ) & \\ & \times & ( {\prod }_{n = 1}^{N} Poisson ( {r}_{n} ; {λ}_{X} ( FRET ( {x}_{n} ) + {λ}_{r} ) ) ) . & ( s16 )\end{matrix}$$

To sample from this distribution, each xₙ can be sampled individually using a Metropolis Hastings step. Separating equation s16 into conditional distributions at each position yields three equations: a conditional posterior on x₁,

$$( s17 )$$

$$\begin{matrix}\begin{matrix}𝒫 ( {x}_{1} \vert {x}_{2 : N} , {U}_{1 : M}^{*} , ζ , {λ}_{X} , \\ {λ}_{g} , {λ}_{r} , {g}_{1 : N} , {r}_{1 : N} )\end{matrix} ∝ Normal ( {x}_{1} ; R 0 , R {0}^{2} ) \\ \times Normal ( {x}_{2} ; {x}_{1} + \frac{Δ t}{ζ} f ( {x}_{1} ) , \frac{2 Δ tkT}{ζ} ) \\ \times Poisson ( {g}_{1} ; {λ}_{X} ( 1 - FRET ( {x}_{1} ) ) + {λ}_{g} ) ) \\ \times Poisson ( {r}_{1} ; {λ}_{X} ( FRET ( {x}_{1} ) + {λ}_{r} ) ) ,\end{matrix}$$

an equation for each xₙ from time levels 2 to N−1,

$$( s18 )$$

$$\begin{matrix}\begin{matrix}𝒫 ( {x}_{n} \vert {x}_{1 : n - 1 , n + 1 : N} , {U}_{1 : M}^{*} , ζ , {λ}_{X} , \\ {λ}_{g} , {λ}_{r} , {g}_{1 : N} , {r}_{1 : N} )\end{matrix} ∝ Normal ( {x}_{n} ; {x}_{n - 1} + \frac{Δ t}{ζ} f ( {x}_{n - 1} ) , \frac{2 Δ tkT}{ζ} ) \\ \times Normal ( {x}_{n + 1} ; {x}_{n} + \frac{Δ t}{ζ} f ( {x}_{n} ) , \frac{2 Δ tkT}{ζ} ) \\ \times Poisson ( {g}_{1} ; {λ}_{X} ( 1 - FRET ( {x}_{n} ) ) + {λ}_{g} ) ) \\ \times Poisson ( {r}_{n} ; {λ}_{X} ( FRET ( {x}_{n} ) + {λ}_{r} ) ) ,\end{matrix}$$

and an equation for the last position, x_{N},

$$( s19 )$$

$$\begin{matrix}\begin{matrix}𝒫 ( {x}_{N} \vert {x}_{1 : N - 1} , {U}_{1 : M}^{*} , ζ , {λ}_{X} , \\ {g}_{1 : N} , {r}_{1 : N} )\end{matrix} ∝ Normal ( {x}_{N} ; {x}_{N - 1} + \frac{Δ t}{ζ} f ( {x}_{N - 1} ) , \frac{2 Δ tkT}{ζ} ) \\ \times Poisson ( {g}_{N} ; {λ}_{X} ( 1 - FRET ( {x}_{N} ) ) + {λ}_{g} ) ) \\ \times Poisson ( {r}_{N} ; {λ}_{X} ( FRET ( {x}_{n} ) + {λ}_{r} ) ) .\end{matrix}$$

### 2.10-Potential

The conditional distribution for the potential is the product of the discretized Langevin equation (equation 5) and the prior on the potential (equation 17),

$$𝒫 ( {U}_{1 : M}^{*} \vert {x}_{1 : N} , ζ , {λ}_{X} , {λ}_{g} , {λ}_{r} , {g}_{1 : N} , {r}_{1 : N} ) ∝ Normal ( {U}_{1 : M}^{*} ; 0 , K ) {\prod }_{n = 2}^{N} Normal ( {x}_{n} ; {x}_{n - 1} + \frac{Δ t}{ζ} f ( {x}_{n - 1} ) \frac{2 Δ tkT}{ζ} ) \qquad ( s20 )$$

which can be simplified to,

$$( {U}_{1 : M}^{*} \vert {x}_{1 : N} , ζ , {λ}_{X} , {λ}_{g} , {λ}_{γ} , {g}_{1 : N} , {r}_{1 : N} ) = Normal ( {U}_{1 : M}^{*} ; \tilde{μ} , \tilde{K} ) \qquad ( s21 )$$

$$\tilde{K} = {( {K}^{- 1} + \frac{Δ t}{2 ζ kT} {K}^{- 1} {K}^{* T} {K}^{*} {K}^{- 1} )}^{- 1} \qquad ( s22 )$$

$$\tilde{μ} = \frac{Δ t}{2 kT} \tilde{K} {K}^{- I} {K}^{* T} {ν}_{1 : N - 1} \qquad ( s23 )$$

where K is the kernel matrix (covariance matrix) between all U*_{1:M}, K* is the covariance between the potential at x*_{1:M} and the force at x_{1:N} with elements K*ₙₘ=−∇k(xₙ,x*ₘ), and v_{1:N-1} are the velocities at each time level with elements vₙ=(xₙ₊₁−xₙ)/Δt. As the final distribution for U*_{1:M} is Gaussian, U*_{1:M} can be directly sampled from the posterior without invoking Metropolis Hastings.

### 2.11-Photon Rates

The conditional distribution on the excitation rate is the product of the likelihood (equations 7 and 6) and the prior on excitation rate (equation 12),

$$( {λ}_{X} \vert {U}_{1 M}^{*} , {x}_{1 N} , {λ}_{g} , {λ}_{r} , ζ , {g}_{1 : N} , {r}_{1 : N} ) ∝ Gamma ( {λ}_{X} ; {κ}_{{λ}_{X}} ; {θ}_{{λ}_{X}} ) \qquad ( s24 )$$

$$\times ( {\prod }_{n = 1}^{N} Poisson ( {g}_{N} ; Δ t {D}_{g} ( {λ}_{X} {f}_{g} ( {x}_{N} ) + {λ}_{g} ) ) )$$

$$\times ( {\prod }_{n = 1}^{N} Poisson ( {r}_{N} ; Δ t {D}_{r} ( {λ}_{X} {f}_{r} ( {x}_{n} ) + {λ}_{r} ) ) ) .$$

The distributions for the background rates λᵣ and λ_{g} can be constructed in an identical manner except for the prior for which the Gamma term (Gamma (λ_{X};κ_{λ}_{_{X}};θ_{λ}_{_{X}}) of equation s24 can be replaced with equation 13 for 1, or equation 14 for λ_{g}. To sample from either distribution, Metropolis Hastings can be applied by proposing a sample at each iteration of the Gibbs sampler and accepting or rejecting based on the relative probabilities of the proposed sample compared to the old sample.

### 2.12-Friction Coefficient

The conditional distribution over the friction coefficient is the product of the discretized Langevin equation (equation 5) and the prior on friction (equation 15)

$$( ζ \vert {U}_{1 : M}^{*} , {x}_{1 : N} , {λ}_{X} , {g}_{1 : N} , {r}_{1 : N} ) ∝ Gamma ( ζ ; {κ}_{ζ} , {θ}_{ζ} ) {\prod }_{n = 2}^{N} Normal ( {x}_{n} ; {x}_{n - 1} + \frac{Δ t}{ζ} f ( {x}_{n - 1} ) , \frac{2 Δ tkT}{ζ} ) . \qquad ( s25 )$$

To sample from this distribution, a Metropolis Hastings step can be applied by proposing a sample at each iteration of the Gibbs sampler and accepting or rejecting based on the relative probabilities of the proposed sample compared to the old sample.

### 2.13 Bayesian Hidden Markov Model

For validation, the energy landscape learned using SKIPPER-FRET is compared to an energy landscape learned using a Bayesian Hidden Markov Model (HMM). This section briefly describes the structure of the HMM algorithm, then explains how the Bayesian HMM analysis results can be used to infer potential energy landscapes for comparison with those inferred by SKIPPER-FRET.

Briefly, HMMs work by assuming that the system under consideration has a discrete number of states, k=1, 2, . . . , K, governed by a transition matrix, q=[qᵢⱼ]κ×κ. At each time level n, the system's state, sₙ, is conditioned on the state of the system at the previous time level, sₙ₋₁, given the transition matrix, q,

$$( {s}_{n} \vert {s}_{n - 1} , q ) = Categorical ( {s}_{n} ; {q}_{{s}_{n - 1}} ) \qquad ( s26 )$$

where qₛ_{_{n−1}} coincides with the row of q corresponding to sₙ₋₁. Put differently, the probability that sₙ=j given that sₙ₋₁=i is equal to qᵢⱼ.

Each state, k, has its own pair distance, rₖ. At each time level, the measured number of photons is conditioned on the pair distance of the system's state at that time level

$$( {g}_{n} ) = Poisson ( {g}_{n} ; Δ t {D}_{g} ( {λ}_{X} {f}_{g} ( {r}_{{s}_{n}} ) + {λ}_{g} ) ) \qquad ( s27 )$$

$$( {r}_{n} ) = Poisson ( {r}_{n} ; Δ t {D}_{r} ( {λ}_{X} {f}_{r} ( {r}_{{s}_{n}} ) + {λ}_{r} ) ) \qquad ( s28 )$$

where fᵣ(x) and f_{g}(x) are the FRET rates, including crosstalk terms, defined by equation 9. Notice that this likelihood is equivalent to the SKIPPER-FRET likelihood, equations 6 and 7.

Working within the Bayesian paradigm, priors can be placed on all unknowns,

$$( {s}_{1} ) = Categorical ( {s}_{1} ; {a}_{q} ) \qquad ( s29 )$$

$$( {r}_{k} ) = Gamma ( {r}_{k} ; {κ}_{r} , {θ}_{r} ) \qquad ( s30 )$$

$$( {λ}_{x} ) = Gamma ( {λ}_{X} ; {κ}_{{λ}_{X}} , {θ}_{{λ}_{X}} ) \qquad ( s31 )$$

$$( {λ}_{g} ) = Gamma ( {λ}_{g} ; {κ}_{{λ}_{g}} , {θ}_{{λ}_{g}} ) \qquad ( s32 )$$

$$( {λ}_{r} ) = Gamma ( {λ}_{r} ; {κ}_{{λ}_{r}} , {θ}_{{λ}_{r}} ) \qquad ( s33 )$$

$$( {q}_{k} ) = Dirichlet ( {q}_{k} ; {a}_{q} ) \qquad ( s34 )$$

where Dirichlet (α_{q}) is the Dirichlet distribution, conjugate to the Dirichlet dynamics model (equation s26). Hyperparameters are selected as α_{q}=[1/K, 1/K, . . . , 1/K], κᵣ=2, and θᵣ=R₀.

Equations (s26) to (s34) form a high-dimensional posterior. This posterior can similarly be sampled using Gibbs sampling and the forward filter-backward sampling algorithm. Once enough samples have been generated, the sample average can be used to provide a point estimate for each variable.

In order to compare the HMM method to SKIPPER-FRET in the Results section above, the HMM results are used to estimate the energy of each state. The energy of each state is calculated using the transition probability matrix, q. The energies from q can be found by first calculating the equilibrium state probabilities, P, defined as,

$$P = qP \qquad ( s35 )$$

then equating P to the Boltzmann distribution,

$$P = \frac{1}{Z} [ \begin{matrix}{e}^{- \frac{{E}_{1}}{kT}} \\ {e}^{- \frac{{E}_{2}}{kT}} \\ ⋯ \\ {e}^{- \frac{{E}_{K}}{kT}}\end{matrix} ] . \qquad ( s36 )$$

Together, equations s35 and s36 allow us to calculate the energy of each state in the HMM model.

2.14-Barrier Heights within HMM Paradigm

This section highlights how one would, if required, compute barrier heights within an HMM paradigm under two regimes: 1) when features of the barrier are known; or 2) when data are collected at different temperatures in addition to features of the barrier being known. The first regime is focused on here as it is of greater interest to experiments on biomolecules operating under one set of physiological temperatures.

To demonstrate that one could calculate barrier heights between states in the HMM model, assume that the transition probability matrix, q, is the solution to a master equation for a rate matrix, λ,

$$q = exp ( Δ t λ ) . \qquad ( s37 )$$

Solving for λ,

$$λ = logm ( q ) / Δ t \qquad ( s38 )$$

where log m is the matrix logarithm. Assuming that the wells representing each state can be approximated as harmonic oscillators, λ can be related to barrier heights using Kramer's rate equation:

$${λ}_{ij} = \{ \begin{matrix}\frac{D \sqrt{{c}_{i} {c}_{ij}}}{2 π kT} {e}^{- \frac{{E}_{ij} - {E}_{i}}{kT}} & i \neq j \\ - {\sum }_{l \neq i} {λ}_{il} & i = j\end{matrix} \qquad ( s39 )$$

where cᵢ is the curvature of the well defining state i, cᵢⱼ is the curvature of the barrier between states i and j, Eᵢⱼ is the energy of the barrier between states i and j, and D is a diffusion parameter dictating the rate of transitions in the absence of a barrier. Solving for the barrier heights:

$${E}_{ij} = {E}_{i} - kT log ( 2 π {λ}_{ij} kT ) - kT log ( D \sqrt{{c}_{i} {c}_{ij}} ) . \qquad ( s40 )$$

Note that equation (s40) the energy of the barrier, Eᵢⱼ, can only be learned if D, cᵢ, and cᵢⱼ are known. However, D, cᵢ, and cᵢⱼ are internal parameters of the system which are not otherwise easy to deduce. In practice, bounds for barrier height are obtained by using additional approximations and an order of magnitude guess for unknown quantities.

Thus, the inability to infer accurate potential energy barriers from a single data set without knowledge of hidden internal parameters is a clear limitation of HMMs when applied to smFRET data. By contrast, SKIPPER-FRET can learn barrier heights and friction coefficients from a single data set.

2.15-Robustness with Respect to Amount of Data

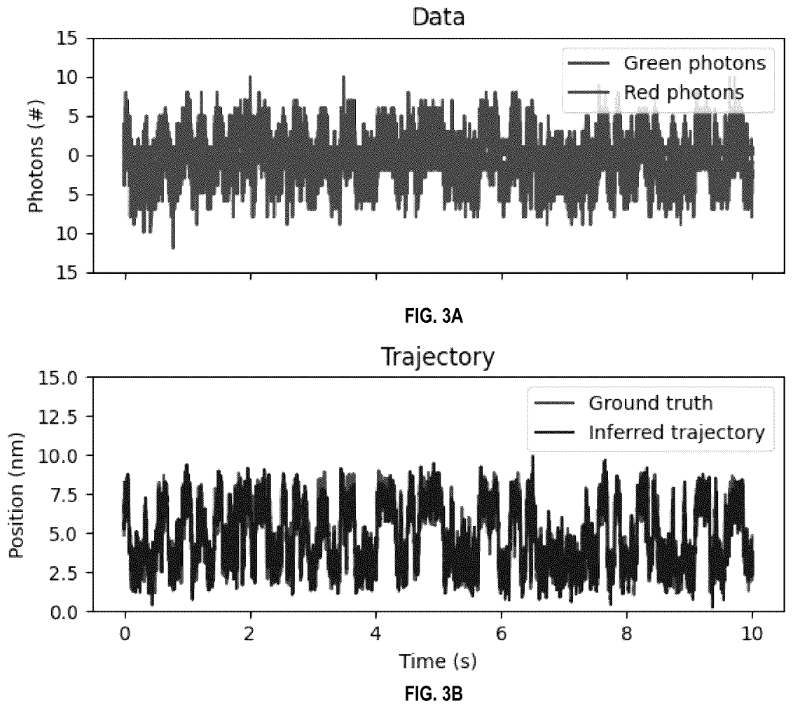

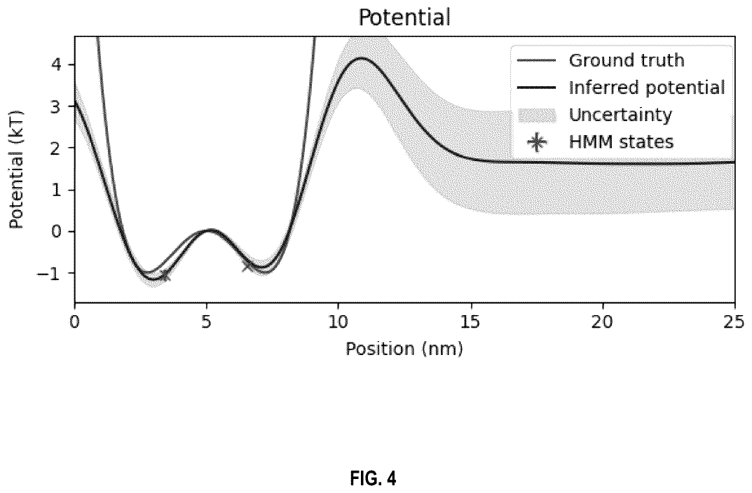

This section tests robustness of SKIPPER-FRET with respect to the length of the data set. That is, this section outlines how well the inferred potential energy landscape matches the ground truth given different number of time levels, N, available in the data. For the robustness test, the same simulated data was used as in the first double well experiment (FIGS. 3A-4), but truncated at different values of N.

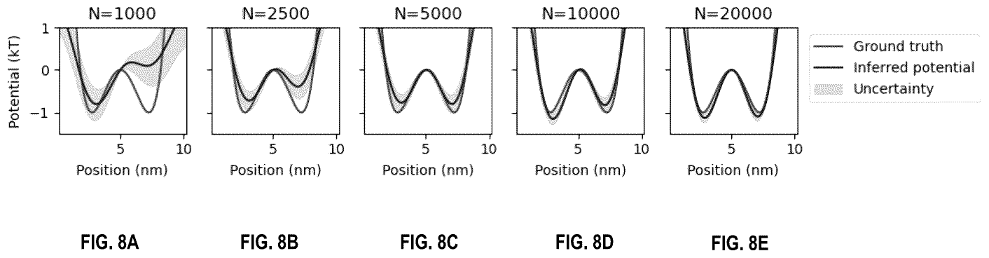

FIGS. 8A-8E show the results of the robustness test with respect to number of data points. Each panel plots the potential inferred using SKIPPER-FRET (blue) against the ground truth potential energy landscape (red) for a given number of measurements, #, listed at the top. As expected, when there are too few time levels for the pair distance to sample both wells, as is the case for N=1000 and N=2500 in FIGS. 8A-8E, SKIPPER-FRET cannot infer an accurate potential energy landscape due to missing data on the other well. When there is a sufficient number of time levels for the pair distance trajectory to sample both wells, as is the case for N≥5000 in FIGS. 8A-8E, then the form of the SKIPPER-FRET potential matches the ground truth potential energy landscape more closely. Generally, FIGS. 8A-8E shows that the accuracy of SKIPPER-FRET increases with the number of time levels, and the uncertainty decreases with the number of data points. Note that SKIPPER-FRET's computation time increases linearly with the number of time levels.

Thus, it is important to ensure sufficient data supplied before applying SKIPPER-FRET. An ideal data set will have enough time for the pair distance to explore all space. For the purposes of this disclosure, N=10000 for all data sets analyzed because this value gave appropriate balance between accuracy and computation speed during development.

As it pertains to analysis of real experiments, of course, SKIPPER-FRET can ascertain the form of the potential for regions visited.

2.16-Robustness Test on Potential with Sharp Dip

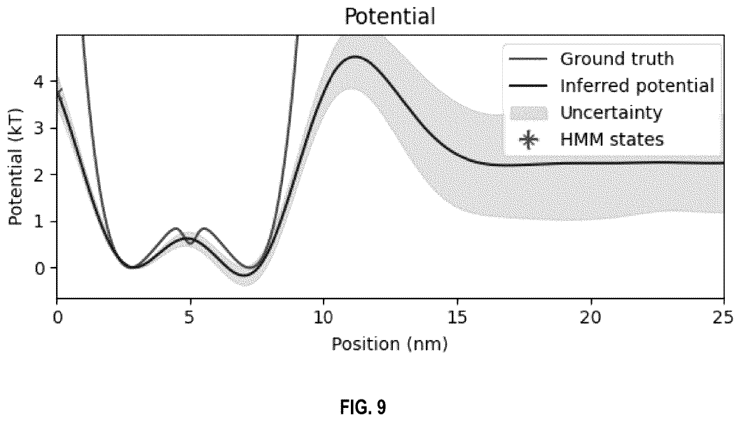

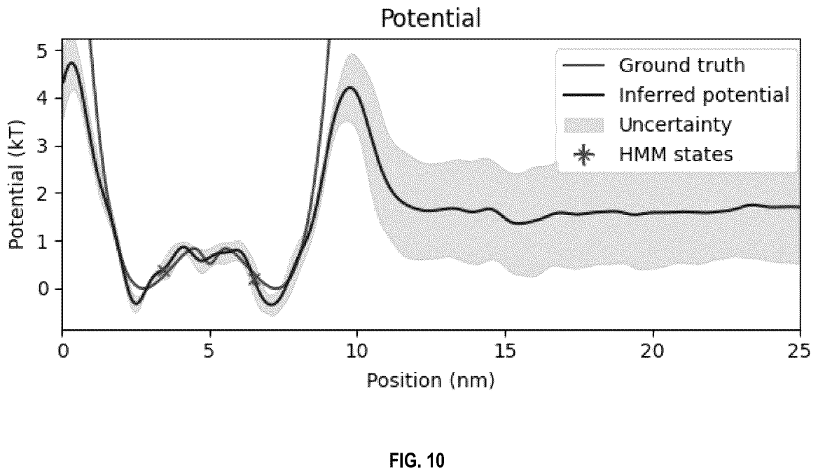

This section demonstrates a failure mode of SKIPPER-FRET when the potential varies on length scales faster than the defined length scale hyperparameter, €. FIG. 9 shows simulated data generated using a potential energy landscape with a “sharp dip”, two large wells and one thin well between them, and plots the inferred potential energy landscape (blue) with uncertainty (light blue) against the ground truth potential energy landscape used in the simulation (red). FIG. 9 additionally plots markers, with uncertainty, indicating the inferred state energy and pair distance using HMMs (green). The common point of zero potential energy was set at the bottom of the leftmost barrier. As seen in FIG. 9, SKIPPER-FRET is able to infer the two large wells accurately, but otherwise misses the small middle well. This is because the length scale hyperparameter, set in equation (18), sets the level of detail the SKI-GP method can infer. In particular, in FIG. 9, a length scale of l=2 nm is used. However, the width of the well is on the order of 1 nm. On the other hand, FIG. 10 shows that by setting the length scale hyperparameter at a small value, to 0.5 nm, SKIPPER-FRET picks up the middle well. The inferred potential energy landscape (blue) with uncertainty (light blue) is plotted against the ground truth potential energy landscape used in the simulation (red), as well as markers with uncertainty indicating the inferred state energy and pair distance using HMMs (green). The common point of zero potential energy was set at the bottom of the leftmost barrier. In practice, setting a smaller length scale may result in having noise dictate the shape of the potential wells, such as the well depth underestimation that appears in FIG. 10. Thus, the potential should be understood as fundamentally coarse-grained on a length scale set by the length hyperparameter.

### 2.17-Evaluating the Friction Coefficient

As there were no means to estimate the ground truth for the friction coefficient for real data, SKIPPER-FRET is compared against an order of magnitude estimate set by typical scales of the problem. A rough estimate can be obtained using dimensional analysis. The units of 3 are mass over time or, equivalently,

$$ζ \approx \frac{Energy \times Time}{{Length}^{2}} . \qquad ( s41 )$$

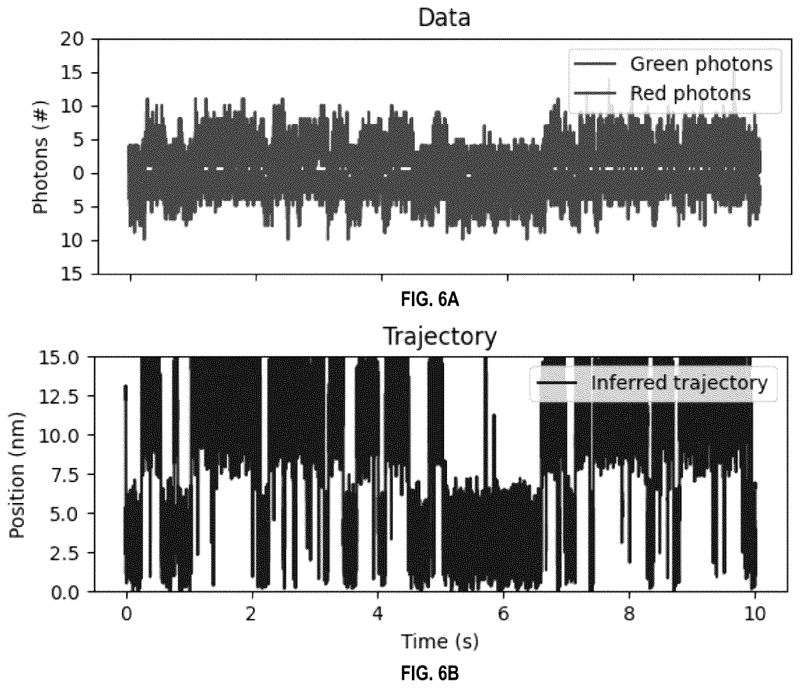

Treating energy scales as kT (with k as Boltzmann's constant and T the temperature, ≈4 pN nm); length scales as the distance between wells≈10 nm; and time scales as the switching times between wells≈0.1 s (see FIGS. 6A and 6B),

$$ζ \approx \frac{( 4 pN nm ) \times ( \text{.1} s )}{{( 10 nm )}^{2}} \qquad ( s42 )$$

$$= 4 mg / s \qquad ( s43 )$$

consistent with the SKIPPER-FRET estimate of 1.54 mg/s.

### 2.18-Parameters Used in the Simulations

The following parameters were used for simulation.

| Δt | 1 | ms |
|---|---|---|
| kT | 4.114 | pNnm |
| ζ | .03 | g/s |
| λ_{X} | 3 | kHz |
| λᵣ | 0 | |
| λ_{g} | 0 | |
| R₀ | 5 | nm |

### 3. Examples

The following Examples are illustrative and should not be interpreted to limit the scope of the claimed subject matter.

In this section, the methods outlined herein are demonstrated on simulated and experimental data. First, the method is shown to can accurately infer the potential energy landscape from simulated smFRET data. The method is further demonstrated on real data from an experiment probing the binding energy landscape between NCBD and ACTR. SKIPPER-FRET results are compared to results obtained using a two state HMM that uses the same likelihood model as SKIPPER-FRET (see section 5.3 of the present disclosure). To be clear, SKIPPER-FRET does not assume a number of potential wells. In comparing SKIPPER-FRET to HMM, an advantage is given to the HMM as it is provided with a number of states coinciding with the number of wells. In section 5 of the present disclosure, the robustness of SKIPPER-FRET is tested with respect to the number of data points. Further, section presents a failure mode when the underlying potential to be inferred has closely-spaced wells.

Simulated data was first analyzed using a simple double-well potential energy landscape. Values used for the simulation can be found in section 5 of the present disclosure. FIGS. 3A and 3B show simulated data and the trajectory inferred by SKIPPER-FRET. FIG. 3A shows the raw data from the experiment including red and green photon counts binned every millisecond. FIG. 3B shows the inferred pair distance trajectory (blue) with the ground truth pair distance trajectory (red). FIG. 4 shows the SKIPPER-FRET potential energy landscape, the ground truth potential energy landscape, and the state energies inferred using a Bayesian HMM. In FIG. 4, the inferred potential energy landscape (blue) with uncertainty (light blue) is plotted against the ground truth potential energy landscape used in the simulation (red). Additionally, markers are plotted, with uncertainty, indicating the inferred state energy and pair distance using the HMM method (green). The common point of zero potential energy was set at the top of the barrier at 5 nm. The HMM does not infer full potential energy landscapes, but rather just the energy and the pair distance of each state (with the added advantage that both here and elsewhere the HMM is provided with a number of states consistent with the number of potential well minima). As such, a full potential landscape cannot be plotted for the HMM results. Instead, HMM could provide plot point estimates, with uncertainties, indicating the pair distance and energy levels of each state. Indeed, while methods exist to approximate barrier heights between states, such methods necessarily rely on knowledge of other internal parameters of the system such as the friction coefficient and the curvature of the potential at points of inflection (see section 5 of the present disclosure). Note that to compare the results of the methods outlined herein against the ground truth as shown in FIG. 4, a common point of zero potential energy must be defined. Since only potential energy differences (not absolute values) are physical, the reference can be chosen arbitrarily. For the first data set, the common point of zero potential energy was chosen to be the top of the barrier between the wells.

As seen in FIGS. 3A and 3B, the pair distance trajectories inferred by SKIPPER-FRET are largely consistent with ground truth trajectory. To be more quantitative, in FIG. 4 the inferred potential energy landscape well minima and barrier height locations fall within 0.2 nm of the ground truth. The inferred well energies were accurate within 0.1 kT (−1.2±0.1 kT and −0.9±0.1 kT vs −1 kT and −1 kT). SKIPPER-FRET additionally inferred a friction coefficient of 0.033±0.002 g/s which is accurate within 12%.

Note that because the potential is learned up to a constant, and since the point of zero potential energy (the location at which the potential is equal to zero) is set by hand, uncertainty propagation deserves special attention. At the point of zero potential, the potential is precisely defined as zero with no associated uncertainty. As such, the uncertainty in the potential can only grow moving away from the point of zero potential. In regions with an abundance of data, the uncertainty grows more slowly, while in regions where there are fewer data points, the uncertainty grows more rapidly. Thus, it is the rate of change of the uncertainty that depends on the quantity of data. Put differently, since the potential is the integral of the force, the uncertainty in the potential is the integral of uncertainty in the force.

Further, in FIG. 4, while the energies inferred using a Bayesian HMM match the energies inferred using SKIPPER-FRET, the pair distances inferred using the HMM deviate from both the ground truth and SKIPPER-FRET well minima. This is because the HMM ascribes a single specified pair distance to what is, in reality, a continuous range of pair distances near potential well minima. To estimate a single specified pair distance, the HMM finds itself effectively averaging the FRET efficiencies over those portions of the trajectory it deems as belonging to one state. This effective pair distance averaging is further complicated when the pair distance trajectory crosses a barrier in which case the HMM must somehow ascribe the dynamics when surmounting the barrier, which it cannot model, to one of the states.

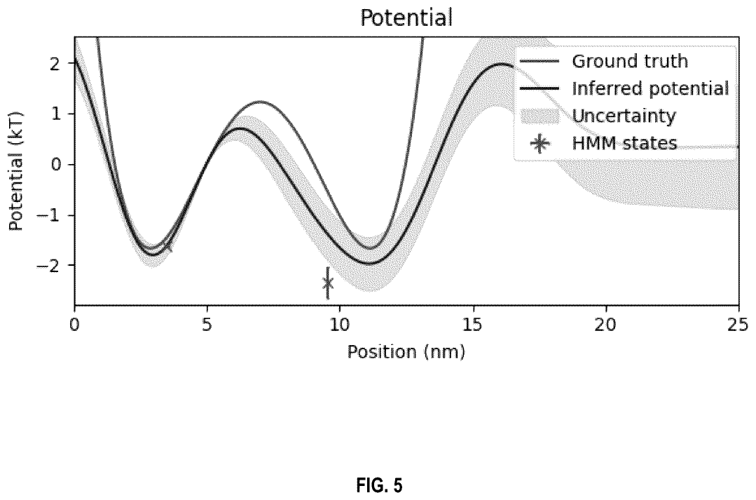

Next, simulated data from a double-well potential was analyzed, where the far rightmost well is centered beyond the range of traditional smFRET measurements (at distance>2R₀ where less than 2% of absorbed photons are transferred to the acceptor). Such a potential mimics the data that can be expected from the binding experiments discussed further herein. FIG. 5 shows results of a simulated potential energy landscape when one barrier is far from the characteristic FRET distance, where the point of zero potential energy is set at the bottom of the leftmost well. The data was simulated using an energy landscape in which one of the wells is outside of the characteristic FRET range. The inferred potential energy landscape (blue) with uncertainty (light blue) is plotted against the ground truth potential energy landscape used in the simulation (red). FIG. 5 also includes markers, with uncertainty, indicating the inferred state energy and pair distance using the HMM method (green). The common point of zero potential energy was set at the bottom of the leftmost well at 2.87 nm. As seen in FIG. 5, SKIPPER-FRET can infer the shape of the left well (where most photons are collected) and still manages to deduce, albeit with reduced accuracy, the shape of the barrier and the far well. The ground truth potential is enclosed within the uncertainty regions (one standard deviation) of the estimates provided by SKIPPER-FRET at almost every point along the left well. SKIPPER-FRET further infers a barrier height of about 2.5 kT which is within 0.5 kT of the ground truth barrier height (2.9 kT). On the right side of the barrier where the FRET efficiency drops dramatically, inherently leaving less information to inform the shape of the potential inferred, the estimate provided by SKIPPER-FRET deviates from the ground truth with a correspondingly growing uncertainty.

Roughly speaking, one cannot expect to be able to accurately infer the potential at locations where the number of expected photons is of order unity. The maximum distance that can be probed, x_{MAX}, can be approximated as the largest distance where the number of photons transferred from the donor to the acceptor (given by excitation rate times the probability of FRET, λ_{X}FRET is greater than or approximately equal to unity. In other words, 1≈λ_{X}(1+(x_{MAX}/R₀)⁶)⁻¹ and thus

$${x}_{MAX} \approx {R}_{0} {( {λ}_{X} - 1 )}^{1 / 6} . \qquad ( 21 )$$

SKIPPER-FRET additionally infers a friction coefficient of 0.035±0.02 g/s which is accurate within 20% of the ground truth. When comparing to the HMM method, that the HMM method and SKIPPER-FRET are again shown to estimate similar energies, but different well locations.

After successfully testing SKIPPER-FRET on simulated data, the present disclosure moves on to analysis of experimental data. FIGS. 6A and 6B, show the inferred trajectory by applying SKIPPER-FRET to data from ACTR-NCBD binding-unbinding experiments. FIG. 6A shows the raw data from the experiment including red and green photon counts. FIG. 6B shows the inferred pair distance trajectory (blue). Based on independent analysis, two states, are expected, corresponding to bound and unbound states. Furthermore, looking at the raw data in FIG. 6A, notice that there are alternating sections of high and low FRET efficiency in what appears to be two states. The corresponding inferred pair distance trajectory, as seen in FIG. 6B, also alternates between two levels as expected.

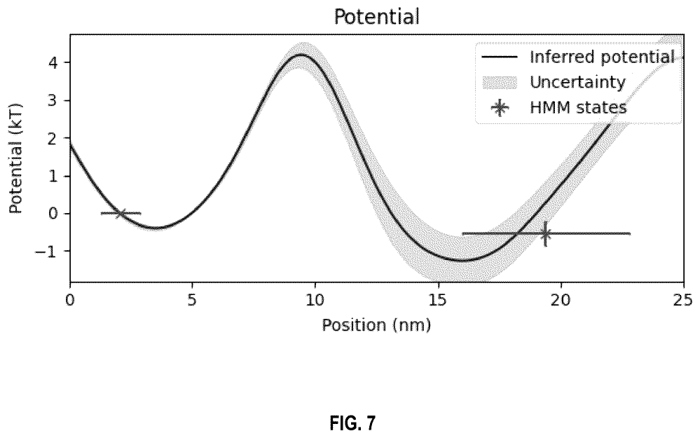

FIG. 7 shows the inferred potential energy landscape for NCBD-ACTR from SKIPPER-FRET (blue) with uncertainty (light blue) compared to the relative potential energy landscape inferred using standard HMM methods. FIG. 7 additionally plots markers, with uncertainty, indicating the inferred state energy and pair distance using the HMM method (green). Indeed, as expected, a double well is recovered by SKIPPER-FRET. The left well in FIG. 7 can be interpreted as the binding energy between ACTR and NCBD, while the right well can be interpreted as the chemical potential energy required to remove NCBD from a volume surrounding the ACTR.

As the true energy landscape for ACTR-NCBD binding is unknown, results of SKIPPER-FRET are compared to the energy landscape inferred using a two state Bayesian HMM model with the same likelihood model as SKIPPER-FRET (see sections 5.3 and 5.4 of the present disclosure). As seen in FIG. 7, the energies inferred using the HMM method fall within the uncertainty regions, but position of the wells inferred using SKIPPER-FRET differ from those inferred using the HMM method. As explained earlier, this arises because fundamentally, the HMM attempts to reconcile its discrete state picture with the Langevin model's continuous formulation. As the HMM method does not provide barrier height, the barrier inferred using SKIPPER-FRET cannot naturally be compared within the HMM paradigm without additional information. Lastly, a friction coefficient of 1.54±0.05 mg/s is inferred. While there is a lack of ground truth to verify this estimate, this value is consistent with dimensional analysis estimates from the data (section 5.7 of the present disclosure).

### 3.1. Computer-Implemented System

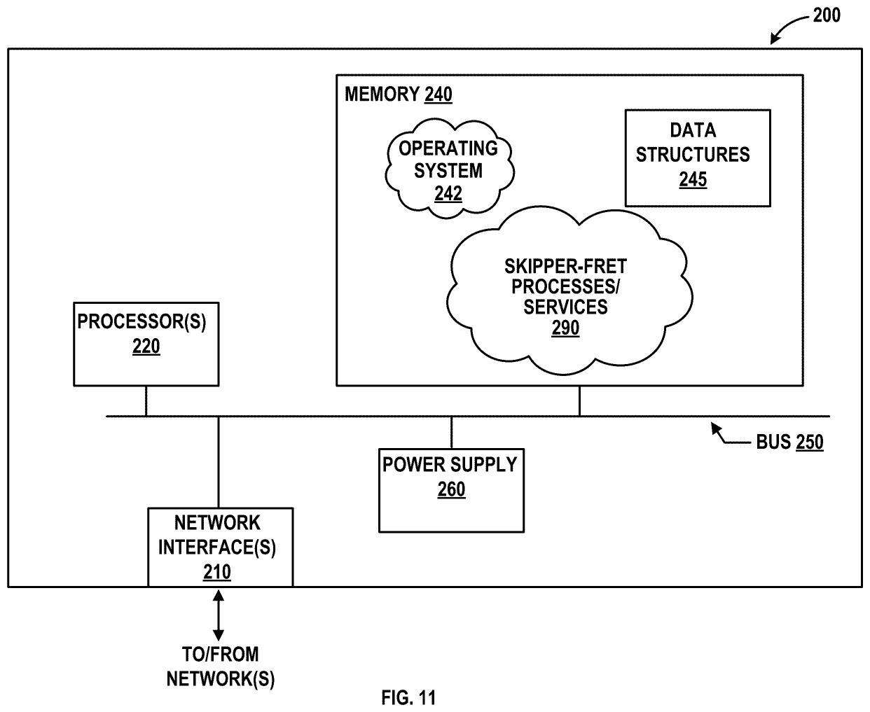

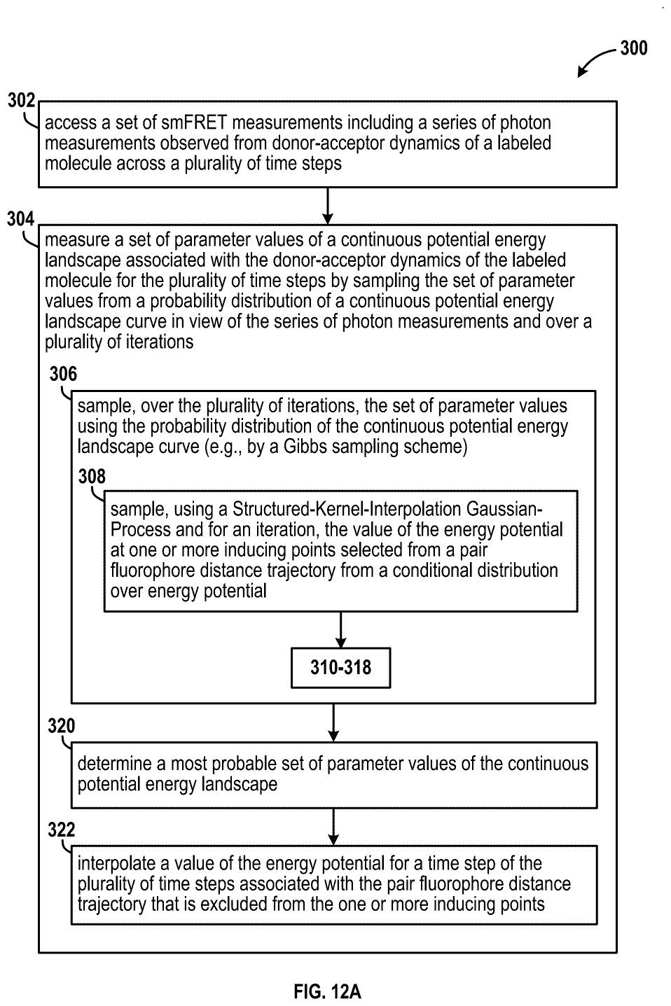

FIG. 11 is a schematic block diagram of an example device 200 that may be used with one or more embodiments described herein, e.g., as a component of system 100 implementing SKIPPER-FRET shown in FIGS. 1A and 1B.

Device 200 comprises one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over the communication links coupled to a communication network. Network interfaces 210 are configured to transmit and/or receive data using a variety of different communication protocols. As illustrated, the box representing network interfaces 210 is shown for simplicity, and it is appreciated that such interfaces may represent different types of network connections such as wireless and wired (physical) connections. Network interfaces 210 are shown separately from power supply 260, however it is appreciated that the interfaces that support PLC protocols may communicate through power supply 260 and/or may be an integral component coupled to power supply 260.

Memory 240 includes a plurality of storage locations that are addressable by processor 220 and network interfaces 210 for storing software programs and data structures associated with the embodiments described herein. In some embodiments, device 200 may have limited memory or no memory (e.g., no memory for storage other than for programs/processes operating on the device and associated caches). Memory 240 can include instructions executable by the processor 220 that, when executed by the processor 220, cause the processor 220 to implement aspects of the system 100 and associated methods outlined herein.

Processor 220 comprises hardware elements or logic adapted to execute the software programs (e.g., instructions) and manipulate data structures 245. An operating system 242, portions of which are typically resident in memory 240 and executed by the processor, functionally organizes device 200 by, inter alia, invoking operations in support of software processes and/or services executing on the device. These software processes and/or services may include SKIPPER-FRET processes/services 290, which can include aspects of the methods and/or implementations of various modules described herein. Note that while SKIPPER-FRET processes/services 290 is illustrated in centralized memory 240, alternative embodiments provide for the process to be operated within the network interfaces 210, such as a component of a MAC layer, and/or as part of a distributed computing network environment. Further, the memory 240 can be a non-transitory computer readable media including instructions (e.g., SKIPPER-FRET processes/services 290) encoded thereon that are executable by a processor to perform aspects of the methods outlined herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the SKIPPER-FRET processes/services 290 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

### 3.2 Method/Process

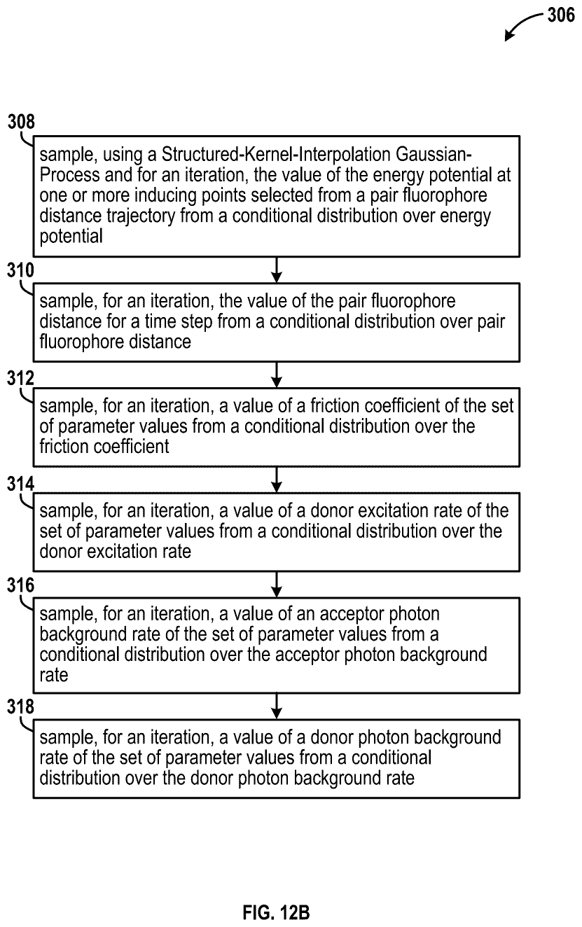

FIGS. 12A and 12B illustrate a process 300 which can embody aspects of the system 100, including SKIPPER-FRET processes/services 290 and the examples discussed herein with respect to in FIGS. 1A-2B.

Referring to FIG. 12A, step 302 of process 300 includes accessing a set of smFRET measurements including a series of photon measurements observed from donor-acceptor dynamics of a labeled molecule across a plurality of time steps t_{1:N}. The labeled molecule can include a donor fluorophore having a donor photon emission rate and an acceptor fluorophore having an acceptor photon emission rate, the donor photon emission rate and the acceptor photon emission rate correlating with a pair fluorophore distance between the donor fluorophore and the acceptor fluorophore. The series of photon measurements can include, for a time step of the plurality of time steps, a donor photon count (r_{1:N}) of photons emitted from the donor fluorophore and an acceptor photon count (g_{1:N}) of photons emitted from the acceptor fluorophore.

Step 304 of process 300 includes measuring a set of parameter values (U*_{1:M}, X_{1:N}, ζ, λ_{X}, λ_{g}, λᵣ) of a continuous potential energy landscape associated with the donor-acceptor dynamics of the labeled molecule for a time step of the plurality of time steps by sampling the set of parameter values from a probability distribution ( [symbol] (U*_{1:M},x_{1:N},ζ,λ_{X},λ_{g},λᵣ|r_{1:N},g_{1:N})) of a continuous potential energy landscape curve in view of the series of photon measurements (r_{1:N}, g_{1:N}) and over a plurality of iterations i. Step 304 can correspond with the Algorithm in Section 2.5 and can include various sub-steps, including steps 306-322 (where steps 310-318 are shown in FIG. 12B).

Step 306 of process 300 can be part of step 304, and can include sampling, over the plurality of iterations, the set of parameter values using the probability distribution of the continuous potential energy landscape curve. This can be achieved using a Gibbs sampling scheme as outlined herein. Step 306 can include steps 308-318 directed to iterative sampling different parameter values of the plurality of parameter values (e.g., by the Gibbs sampling scheme) from individual probability distributions that form the probability distribution of the continuous potential energy landscape curve, where steps 310-318 are shown in FIG. 12B.

Step 308 of process 300 includes sampling, using a Structured-Kernel-Interpolation Gaussian-Process and for an iteration of the plurality of iterations, the value of the energy potential (U*_{1:M}⁽ⁱ⁺¹⁾) at one or more inducing points (x*_{1:M}) (selected from a pair fluorophore distance trajectory (x_{1:N}) where M<N) from a conditional distribution over energy potential (e.g., from [symbol] (U*_{1:M}|x_{1:N}⁽ⁱ⁾,ζ⁽ⁱ⁾,λ_{X}⁽ⁱ⁾,λ_{g}⁽ⁱ⁾,λᵣ⁽ⁱ⁾,r_{1:N},g_{1:N}) as in Step 2 of the Algorithm in Section 2.5). Note that step 308 relates to step 322 shown in FIG. 12A, although step 322 may be applied after completion of steps 308-320 over the plurality of iterations (e.g., after the sampling scheme “settles” on a most probable set of parameter values).

Steps 310-318 of process 300 (more precisely, of step 306) are shown in FIG. 12B, and can be performed iteratively over the duration of the sampling step of 306.

Step 310 includes sampling, for an iteration of the plurality of iterations, the value of the pair fluorophore distance x_{1:N}⁽ⁱ⁺¹⁾ for a time step from a conditional distribution over pair fluorophore distance (e.g., from [symbol] (x_{1:N}|U*_{1:M}⁽ⁱ⁺¹⁾,ζ⁽ⁱ⁾,λ_{X}⁽ⁱ⁾,λ_{g}⁽ⁱ⁾,λᵣ⁽ⁱ⁾, r_{1:N},r_{1:N}) as in Step 2 of the Algorithm in Section 2.5).

Step 312 includes sampling, for an iteration of the plurality of iterations, a value of a friction coefficient ζ⁽ⁱ⁺¹⁾ of the set of parameter values from a conditional distribution over the friction coefficient (e.g., from [symbol] (ζ|U*_{1:M}⁽ⁱ⁺¹⁾,x_{1:N}⁽ⁱ⁺¹⁾,λ_{X}⁽ⁱ⁾,λ_{g}⁽ⁱ⁾,λᵣ⁽ⁱ⁾,r_{1:N},g_{1:N}) as in Step 2 of the Algorithm in Section 2.5).

Step 314 includes sampling, for an iteration of the plurality of iterations, a value of a donor excitation rate λ_{X}⁽ⁱ⁺¹⁾ of the set of parameter values from a conditional distribution over the donor excitation rate (e.g., from [symbol] (λ_{X}|U*_{1:M}⁽ⁱ⁺¹⁾,x_{1:N}⁽ⁱ⁺¹⁾,ζ⁽ⁱ⁺¹⁾,λ_{g}⁽ⁱ⁾,λᵣ⁽ⁱ⁾,r_{1:N},g_{1:N}) as in Step 2 of the Algorithm in Section 2.5), the conditional distribution over the donor excitation rate correlating with a probability associated with observing the series of photon measurements.

Step 316 includes sampling, for an iteration of the plurality of iterations, a value of an acceptor photon background rate λ_{g}⁽ⁱ⁺¹⁾ of the set of parameter values from a conditional distribution over the acceptor photon background rate (e.g., from [symbol] (λ_{g}|U*_{1:M}⁽ⁱ⁺¹⁾,x_{1:N}⁽ⁱ⁺¹⁾,ζ⁽ⁱ⁺¹⁾,λ_{X}⁽ⁱ⁺¹⁾, λᵣ⁽ⁱ⁾,r_{1:N},g_{1:N}) as in Step 2 of the Algorithm in Section 2.5), the conditional distribution over the acceptor photon background rate correlating with a probability associated with observing the series of photon measurements.

Step 318 includes sampling, for an iteration of the plurality of iterations, a value of a donor photon background rate λᵣ⁽ⁱ⁺¹⁾ of the set of parameter values from a conditional distribution over the donor photon background rate (e.g., from [symbol] (λᵣ|U*_{1:M}⁽ⁱ⁺¹⁾,x_{1:N}⁽ⁱ⁺¹⁾,ζ⁽ⁱ⁺¹⁾,λ_{N}⁽ⁱ⁺¹⁾,λ_{g}⁽ⁱ⁺¹⁾, r_{1:N},g_{1:N}) as in Step 2 of the Algorithm in Section 2.5), the conditional distribution over the donor photon background rate correlating with a probability associated with observing the series of photon measurements.

Returning to FIG. 12A, step 320 can follow step 306 (which includes steps 308-318) and can include determining a most probable set of parameter values of the continuous potential energy landscape based on the set of parameter values sampled using the probability distribution of the continuous potential energy landscape curve over the plurality of iterations.

Step 322 can also follow step 306, and includes interpolating a value of the energy potential (U_{1:N} or U(x)) for a time step of the plurality of time steps associated with the pair fluorophore distance trajectory x_{1:N} that is excluded from the one or more inducing points (x*_{1:M}). As mentioned above, step 322 corresponds with step 308 and serves to recover the potential energy values along the full pair fluorophore distance trajectory (as step 308 only samples the energy potential at the inducing points (x*_{1:M}) which are a subset of the pair fluorophore distance trajectory (x_{1:N})).

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

### 4. Conclusion

Inferring accurate potential energy landscapes is a critical step toward unraveling key biophysical phenomena including protein folding, binding, and the dynamics of molecular motors. Here, the present disclosure outlines SKIPPER-FRET, which is orthogonal to the HMM paradigm to include continuous states which also yields barrier heights. SKIPPER-FRET method on simulated and experimental data.

The present disclosure shows that, if warranted, it is possible to avoid making the discrete state assumption inherent to HMMs. The HMM only has access to energy barriers between states it is supplied with preexisting knowledge of the internal parameters of the reaction coordinate, or if there are at least two data sets taken at different temperatures (see SI section 40). This is despite any single data set already encoding this information.

Key to the inference algorithm of SKIPPER-FRET is the structured kernel interpolation Gaussian process (SKI-GP), which enables sampling of the potential energy landscape from a prior over all continuous curves while avoiding the costly cubic scaling requirements of a standard Gaussian process. Specifically, with the SKI-GP prior, it is possible to define inducing point locations, x*_{1:M} separate from the trajectory, x_{1:N}, to avoid calculating a new covariance matrix, K, and its inverse, K⁻¹ at each iteration of the Gibbs sampler, thereby saving considerable computational time. This would not be possible using standard Gaussian process techniques.

Moving forward, there are ways in which SKIPPER-FRET may be improved. Firstly, SKIPPER-FRET, as it stands, deals with smFRET data from continuously illuminated sources. However, many smFRET experiments work using pulsed excitation. The measurement model of equation (6)-equation (7) could be modified to accommodate pulsed illumination by swapping the Poisson distribution, which assumes exponential waiting times between excitation, for a Binomial distribution, compatible with fixed window excitations.

Also, SKIPPER-FRET deals with system dynamics along a single reaction coordinate assumed to be equivalent to the FRET pair distance. However, one can imagine situations in which system dynamics are probed along an axis partly orthogonal to the FRET pair distance in a multi-dimensional incarnation of FRET with, say, one donor and multiple acceptor labels. For example, even in the case of ACTR binding to NCBD, analyzed as an example in this disclosure, the ACTR may rotate with respect to the NCBD during binding. Cases with multiple degrees of freedom are traditionally studied using multicolor smFRET or by pairing data analysis with molecular dynamics simulations. In principle, one could use SKIPPER-FRET to infer potentials along degrees of freedom orthogonal to the FRET distance by including some mapping from the desired degree of freedom to the FRET pair distance in equation (8). As the FRET pair distance is often not directly tied to the reaction coordinate this may be a promising direction for future work.

Along these same lines, while the focus of the present disclosure has, so far, been on learning one-dimensional potentials and demonstrating that it is possible to learn barriers and potential shapes, avoiding the costly cubic scaling of standard GPs is also critical in deducing higher dimensional potentials. For instance, a HMM may, for example, distinguish between a fully connected and linear three-state model. Here, the one-dimensional reduction would need to be augmented to two dimensions in order to deduce these types of higher-dimensional features. Deducing features, such as potential ridges and valleys, in higher dimensions is the object of future work.

What is claimed is:

1. A system, comprising:
a processor in communication with a memory, the memory including instructions executable by the processor to:
access a set of smFRET measurements including a series of photon measurements observed from donor-acceptor dynamics of a labeled molecule across a plurality of time steps; and
measure a set of parameter values of a continuous potential energy landscape associated with the donor-acceptor dynamics of the labeled molecule for a time step of the plurality of time steps by sampling the set of parameter values from a probability distribution of a continuous potential energy landscape curve in view of the series of photon measurements and over a plurality of iterations;
the set of parameter values of the continuous potential energy landscape curve including a value of an energy potential that correlates with a pair fluorophore distance of the labeled molecule for the time step of the plurality of time steps.

2. The system of claim 1, the labeled molecule including a donor fluorophore having a donor photon emission rate and an acceptor fluorophore having an acceptor photon emission rate, the donor photon emission rate and the acceptor photon emission rate correlating with the pair fluorophore distance between the donor fluorophore and the acceptor fluorophore.

3. The system of claim 2, the series of photon measurements including, for a time step of the plurality of time steps, a donor photon count of photons emitted from the donor fluorophore and an acceptor photon count of photons emitted from the acceptor fluorophore.

4. The system of claim 1, the memory further including instructions executable by the processor to:
sample, using a Structured-Kernel-Interpolation Gaussian-Process for an iteration of the plurality of iterations, the value of the energy potential at one or more inducing points selected from a pair fluorophore distance trajectory from a conditional distribution over energy potential.

5. The system of claim 4, the memory further including instructions executable by the processor to:
interpolate a value of the energy potential for a time step of the plurality of time steps associated with the pair fluorophore distance trajectory that is excluded from the one or more inducing points.

6. The system of claim 1, the memory further including instructions executable by the processor to:
sample the set of parameter values using the probability distribution of the continuous potential energy landscape curve over the plurality of iterations using a Gibbs sampling scheme.

7. The system of claim 1, the memory further including instructions executable by the processor to:
sample, for an iteration of the plurality of iterations, the value of the pair fluorophore distance for a time step from a conditional distribution over pair fluorophore distance.

8. The system of claim 1, the memory further including instructions executable by the processor to:
sample, for an iteration of the plurality of iterations, a value of a friction coefficient of the set of parameter values from a conditional distribution over the friction coefficient.

9. The system of claim 1, the memory further including instructions executable by the processor to:
sample, for an iteration of the plurality of iterations, a value of a donor excitation rate of the set of parameter values from a conditional distribution over the donor excitation rate, the conditional distribution over the donor excitation rate correlating with a probability associated with observing the series of photon measurements.

10. The system of claim 1, the memory further including instructions executable by the processor to:
sample, for an iteration of the plurality of iterations, a value of a donor photon background rate of the set of parameter values from a conditional distribution over the donor photon background rate, the conditional distribution over the donor photon background rate correlating with a probability associated with observing the series of photon measurements.

11. The system of claim 1, the memory further including instructions executable by the processor to:
sample, for an iteration of the plurality of iterations, a value of an acceptor photon background rate of the set of parameter values from a conditional distribution over the acceptor photon background rate, the conditional distribution over the acceptor photon background rate correlating with a probability associated with observing the series of photon measurements.

12. The system of claim 1, the memory further including instructions executable by the processor to:
determine a most probable set of parameter values of the continuous potential energy landscape based on the set of parameter values sampled using the probability distribution of the continuous potential energy landscape curve over the plurality of iterations.

13. A method, comprising:
accessing a set of smFRET measurements including a series of photon measurements observed from donor-acceptor dynamics of a labeled molecule across a plurality of time steps, the series of photon measurements including, for a time step of the plurality of time steps, a donor photon count of photons emitted from a donor fluorophore of the labeled molecule and an acceptor photon count of photons emitted from an acceptor fluorophore of the labeled molecule; and
measuring a set of parameter values of a continuous potential energy landscape associated with the donor-acceptor dynamics of the labeled molecule for a time step of the plurality of time steps by sampling the set of parameter values from a probability distribution of a continuous potential energy landscape curve in view of the series of photon measurements and over a plurality of iterations;
the set of parameter values of the continuous potential energy landscape curve including a value of an energy potential that correlates with a pair fluorophore distance of the labeled molecule for the time step of the plurality of time steps.

14. The method of claim 13, further comprising:
sampling, using a Structured-Kernel-Interpolation Gaussian-Process for an iteration of the plurality of iterations, the value of the energy potential at one or more inducing points selected from a pair fluorophore distance trajectory from a conditional distribution over energy potential.

15. The method of claim 13, further comprising:
sampling, for an iteration of the plurality of iterations, the value of the pair fluorophore distance for a time step from a conditional distribution over pair fluorophore distance.

16. The method of claim 13, further comprising:
sampling, for an iteration of the plurality of iterations, a value of a friction coefficient of the set of parameter values from a conditional distribution over the friction coefficient.

17. The method of claim 13, further comprising:
sampling, for an iteration of the plurality of iterations, a value of a donor excitation rate of the set of parameter values from a conditional distribution over the donor excitation rate, the conditional distribution over the donor excitation rate correlating with a probability associated with observing the series of photon measurements.

18. The method of claim 13, further comprising:
sampling, for an iteration of the plurality of iterations, a value of a donor photon background rate of the set of parameter values from a conditional distribution over the donor photon background rate, the conditional distribution over the donor photon background rate correlating with a probability associated with observing the series of photon measurements.

19. The method of claim 13, further comprising:
sampling, for an iteration of the plurality of iterations, a value of an acceptor photon background rate of the set of parameter values from a conditional distribution over the acceptor photon background rate, the conditional distribution over the acceptor photon background rate correlating with a probability associated with observing the series of photon measurements.

20. One or more non-transitory computer readable media including instructions encoded thereon that are executable by a processor to:
access a set of smFRET measurements including a series of photon measurements observed from donor-acceptor dynamics of a labeled molecule across a plurality of time steps, the series of photon measurements including, for a time step of the plurality of time steps, a donor photon count of photons emitted from a donor fluorophore of the labeled molecule and an acceptor photon count of photons emitted from an acceptor fluorophore of the labeled molecule; and
measure a set of parameter values of a continuous potential energy landscape associated with the donor-acceptor dynamics of the labeled molecule for a time step of the plurality of time steps by sampling the set of parameter values from a probability distribution of a continuous potential energy landscape curve in view of the series of photon measurements and over a plurality of iterations;
the set of parameter values of the continuous potential energy landscape curve including a value of an energy potential that correlates with a pair fluorophore distance of the labeled molecule for the time step of the plurality of time steps.
